(19) United States
(12) Patent Application Publication
(10) Pub. No.: US 2013/0031475 A1
(43) Pub. Date: Jan. 31, 2013

(54) SOCIAL NETWORK BASED VIRTUAL ASSEMBLY PLACES

(71) Applicants: Yehonatan Rafael Maor, Tel Aviv (IL); Ofer Rundstein, Tel Aviv (IL); Meishar Meiri, Tel Aviv (IL); Gad Mordechi Maor, Tel Aviv (IL); Adam Rakiv, Tel Aviv (IL); Yossi Sadoun, Tel Aviv (IL)

(72) Inventors: Yehonatan Rafael Maor, Tel Aviv (IL); Ofer Rundstein, Tel Aviv (IL); Meishar Meiri, Tel Aviv (IL); Gad Mordechi Maor, Tel Aviv (IL); Adam Rakiv, Tel Aviv (IL); Yossi Sadoun, Tel Aviv (IL)

(73) Assignee: SCENE 53 INC., Tel aviv (IL)

(21) Appl. No.: 13/275,113

(22) Filed: Oct. 17, 2011

Related U.S. Application Data
(60) Provisional application No. 61/394,151, filed on Oct. 18, 2010.

(51) Int. Cl. G06F 3/048

(52) U.S. Cl. 715/706

(57) ABSTRACT

A method of providing virtual meeting environments for user controlled avatars. Each avatar is associated with user information from at least one social network (Facebook), and the user's profile picture and sex controls the general appearance of the avatars. The avatar's appearance can also be customized according to their user's social network relationships such as friends, friends of friends, or strangers. Various online virtual events, such as virtual parties, meeting rooms and the like may be created, and other social network users invited to participate by sending their avatars to the meeting environment. There the avatars may move about and interact with one another according to real-world rules, such as the rule that only avatars that are portrayed as physically being closely associated to each other in the virtual world may chat or interact, as well as exchange social network user information. Virtual environment search engines are also provided.

### CROSS REFERENCE TO RELATED APPLICATIONS

This application claims the priority benefit of U.S. provisional application 61/394,151 entitled “SOCIAL NETWORK BASED VIRTUAL ASSEMBLY PLACES”, inventors Yehonatan Rafael Maor, Ofer Rundstein, Meishar Meiri, Gad Mordechai Maor, Adam Rakib, and Yossi Sadoun, filed Oct. 18, 2010; the contents of this application are incorporated herein by reference.

### BACKGROUND OF THE INVENTION

The invention is in the general fields of computerized social networks, virtual worlds, and computer simulations of real world environments.

### DESCRIPTION OF THE RELATED ART

Prior art online social networks offer a chance to stay connected with existing friends, meet new people, express one's self and one's thoughts, share photos, links and posts, and also offer additional applications such as games and dating. According to Experian Hitwise market reports, at present, online social networks are dominated by a few companies. Facebook has about 60% of the market, MySpace has about 30% of the market, and the remaining 10% are occupied by various smaller companies such as Twitter, Tagged, and myYearBook. This market has expanded greatly in recent years, and as of April 2010, Facebook had more than 200 million active users each month that spend more than one hour a day on the platform. The average Facebook user has more than 130 registered friends.

At the same time, social games, such as Zynga (makers of popular Facebook games such as Mafia Wars, Farmville, and the like), World of Warcraft, and the like have also become popular. Zynga, for example itself has millions if active users. However these prior art social games generally have user bases that are composed of users who have signed up for the game itself. Although individuals in these games may design avatars (i.e. computer representations of the user's game alter ego) to play the game, these avatars will generally bear little relationship to the user's real life appearance and characteristics. Indeed this is part of the appeal of these games, because a small person in real life, for example, may want to portray themselves as large and imposing in the game.

Previous art in this area includes U.S. Pat. No. 6,772,195 B1, US application US 2009/0271714 A1, US 2008/0040673 A1,

### BRIEF SUMMARY OF THE INVENTION

Despite the proliferation of online social networks and games, methods of meeting new people online are still inadequate. Social networks mainly allow members to connect with friends that they already have met, and online games mainly allow users to connect for the limited purpose of playing the games. Thus there is still nothing that allows an individual to meet new people with the same degree of ease and reliability that exists for example, in a real life social party situation.

In a real life social party, friends may invite other friends, and these friends will in turn invite both friends of friends, and also friends of friends of friends, and so on. Because the initial guest list is at least partially screened, an individual at a real life social party has some assurance that the stranger that they may meet will likely have at least a few things in common with them, because the individual and the stranger are connected by only a few degrees of social separation. This helps insure compatibility, and increases the chance that the meeting may ultimately be found to be worthwhile from a romantic, friendship, political or business perspective.

In real life, one of the reasons why people go to real parties is to expand their social networks, and potentially reap the benefits that an expanded social network brings to almost every area of life. However neither prior art social networks nor prior art social games enable the same type of natural social network expansion that is possible in an everyday party setting, where all party members present will only have at most a few degrees of social separation from each other.

At the same time, due to the statistics of the proliferation of online social networks, and the large amount of time individuals spend interacting online with the social networks each day, the social network environment has tended to supplant much of the time that individuals would, in earlier years, have spent interacting in real life. For example, when the average user with about 130 online friend connections enters a social network, at any given time it is now statistically likely that about 30 of the user's friends will also be online.

In one embodiment, the invention provides a virtual environment or virtual platform where social networks and community website users will be able to gather online much as they would in real life. The goal is to capture as closely as possible the vivid details of real life environments, such as parties, where people can not only meet existing friends, but also meet friends of friends, and more distantly connected individuals, that they might not have a chance to meet otherwise.

In order to do this, a number of different software features and methods are required. These include software features that 1) create a social interaction platform that is layered over a previously established social network populated with real-world data from real-world users; 2) help the user make new acquaintances that are significant to his/hers real life; and 3) provide the user with a guide to various virtual events.

Thus the basic spirit of the invention is to provide social networks and community websites where users can gather and interact online in a manner that is similar to a vivid, real-life event.

Thus in one embodiment, the invention may be a method of providing virtual meeting environments for avatars controlled by human users. Each avatar may be associated with the user information from at least one social network such as Facebook, and the user's profile picture and sex can control the general appearance of the avatars. The avatar appearance can also be customized according to their user's social network relationships such as friends, friends of friends, or strangers. Various online virtual events, such as virtual parties, meeting rooms and the like may be created, and other social network users invited to participate by sending messages inviting the other users to send their avatars to the meeting environment. In the virtual meeting environment, the various avatars may move about and interact with one another according to real-world rules, such as the rule that only avatars that are portrayed as physically being closely associated to each other in the virtual world may chat or interact with each other, as well as exchange social network user information. Various virtual environment search engines are also provided.

### BRIEF DESCRIPTION OF THE DRAWINGS

FIG. 1 shows a Venn diagram of an individual's real-world social network.

FIG. 2 shows a network diagram showing some of the major components of the Agora system.

FIG. 3 shows a web page from a user's Internet based social network, here using Facebook as an example.

FIG. 4 shows an overview of an Agora virtual birthday party, here operating within the associated social network system.

FIG. 5 shows a close-up of the user's avatar, showing his associated social network photograph.

FIG. 6 shows a corner of the virtual room containing a picture wall, jukebox item, and a game. Here the system also shows who has selected the song that is currently being played in the room.

FIG. 7 shows the user examining a picture on the wall, which may be linked to another user's social network photo album.

FIG. 8 shows that clicking on the picture wall provides a magnified view of the picture, along with buttons or hot boxes to allow the user to comment on the photo.

FIG. 9 shows the user reading the social network linked photo comments, and deciding to either write his own comment or not.

FIG. 10 shows a close up of the jukebox item.

FIG. 11 shows a close-up of the dartboard item.

FIG. 12 shows an overview of another part of the social network embedded virtual party, where the user has decided to join a conversation composed of three other user avatars engaged in GeoChat.

FIG. 13 shows the user just before joining GeoChat. Note that the user does not yet have a GeoChat chat balloon.

FIG. 14 shows the user just after joining GeoChat. Now a GeoChat chat balloon has appeared above the user, and the user is now able to hear or read the contents of the GeoChat conversation, and join in with the conversation.

FIG. 15 shows an overview of the portion of the virtual room where the GeoChat is taking place, and also shows one type of GeoChat text interface. Many alternative GeoChat text interfaces are possible, and in other embodiments, the GeoChat interface may be an audio interface, allowing the various GeoChat participants to speak and talk directly using suitable audio equipment.

FIG. 16 shows an example where mousing (e.g. moving a mouse cursor) over another user's avatar can reveal a text link from her social network, such as the user's social network tag line.

FIG. 17 shows that clicking on another user's avatar can cause the Agora system to produce a mini-social network interface that reveals additional information from the other user's social network, and the Agora system can also provide a variety of options for interacting with that other user as well.

FIG. 18 shows a close up of the other user's social network information provided by Agora

FIG. 19 shows a close up of the other user's social network photos page.

FIG. 20 shows that by clicking on one of the other user's photos downloaded to Agora from the social network, the photo can be show in higher detail, while still within the Agora virtual meeting room space. This photo is shown along with additional interface buttons for making comments and providing social network connectivity, such as Facebook connectivity.

FIG. 21 shows another close up of the other user's social network interface, where an option to add the other user as a social network “friend” is given.

FIG. 22 shows the Agora “who's here” interface, again presented within the context of the Agora virtual party or meeting room.

FIG. 23 shows a close up of the Agora “who's here” interface.

FIG. 24 shows a virtual bar portion of the Agora virtual party room. Here the user has clicked on a virtual bar stool.

FIG. 25 shows that the user's avatar sitting on the virtual bar stool.

FIG. 26 shows the user's avatar interacting with the nearby avatar of another user.

FIG. 27 shows the other user's Agora social network interface, along with the various interaction options that are brought up when the other user's avatar is clicked on.

FIG. 28 shows a close up of the various user interaction options.

FIG. 29 shows the result of clicking on the “treat” option. Here the user has purchased a virtual “drink” gift for the other user's avatar.

FIG. 30 shows the result of clicking on the “challenge” option. Here a variety of different game options are presented, again still within the context of the Agora virtual party room.

FIG. 31 shows a close up of the game options panel.

FIG. 32 shows an advertisement for a soft drink that is placed on the wall of the Agora virtual party room.

FIG. 33 shows a different type of promotional advertisement that may be shown as a text overlay.

FIG. 34 shows the user broadcasting a message to the entire virtual party room.

FIG. 35 shows the user presenting an emoticon to the entire virtual party room.

FIG. 36 shows a detail of the portion of the Agora user interface that provides an emoticon control panel.

FIG. 37 shows the Agora user interface that allows the user to capture a webcam camera shot of himself or herself, and present it as an emoticon.

FIG. 38 shows a close up of the Agora camera interface.

FIG. 39 shows a close up of the Agora “invite list” function.

FIG. 40 shows a close up of how an Agora user can invite another friend to an ongoing Agora virtual party room.

FIG. 41 shows the Agora virtual message wall in action.

FIG. 42 shows a close up of the interface to the virtual wall that opens up when the Agora virtual wall is clicked on. This Agora virtual wall can be linked with the corresponding social network wall, such as a Facebook “wall”.

FIG. 43 shows a top portion of the Agora virtual events guide.

FIG. 44 shows a close up of the “where are my friends now?” interface.

FIG. 45 shows a close up of the “upcoming events” interface.

FIG. 46 shows a close up of the “what's hot and happening now?” interface.

FIG. 47 shows a close up of the “join friends”, “plan event” and “hang out now” interface.

FIG. 48 shows a close up of a sponsored singles virtual event.

FIG. 49 shows a close up of a virtual product sales interface.

FIG. 50 shows a close up of a prompt to create a new virtual event.

FIG. 51 shows the “create virtual event” interface.

FIG. 52 shows a close up of an Agora “select a room” interface allowing the user to rapidly create new virtual events.

FIG. 53 shows the “search for virtual events” option.

FIG. 54 shows a close up showing some local events that are retrieved by the Agora virtual event search engine. In some cases, these events can be sponsored events that have both a virtual world component, and a corresponding real world component.

### DETAILED DESCRIPTION OF THE INVENTION

Here, the invention's social network based realistic virtual world will be given the name “Agora” which is the Greek word for an open place of assembly, commercial place, public speaking place and market place. The Roman version of this word is “forum”.

In one embodiment, the invention may be a system and method of providing at least one computer network virtual meeting environment for a plurality of avatars. This method will generally comprise associating each of this plurality of avatars with the human user information from at least one social network, such as Facebook, which itself will be comprised many (often millions) of different human users. Here the social network will preferably be a popular and established social network that already contains user information regarding the real world social interactions between the users (e.g. friends, friends of friends, and so on), user real world photographic information, and user real world biographic information.

The social network user photographic information, such as the user's profile picture user biographic information (such as the user's sex) can be used to provide visual labels and appearances for these avatars, thus producing a plurality of social network labeled avatars.

These social network labeled avatars may be used to populate various online virtual meeting environments. Typically these virtual meeting environments will be populated with various social network labeled avatars, usually by invitation or by a user's finding the virtual event on a virtual event search engine which may be customized for this purpose. These avatar populated virtual meeting environments may be displayed on the graphical user interfaces (often web browsers) of computerized network (often the Internet) connected devices (often computers and/or smart cellular phone devices) running under the control of at least some of the various social network users. Using this system and method, the users may control the movement of their respective social network labeled avatars within these virtual meeting environments, interact with the social network labeled avatars belonging to other users, and obtain at least some social network user information based on these interactions.

Although the invention's Agora social network based, realistic virtual world, may run on a wide variety of different social networks, in view of Facebook's present 60% market share, many of the examples and discussion in this disclosure will use the Facebook social network as an example, and will also use the Facebook social network naming convention to describe various social network functions. This use of Facebook examples and terminology is intended as a concise way to convey some of the complex social network functionality, but is not intended to be limiting. In alternative embodiments, the invention may be run on other social networks (e.g. MySpace) and may employ functionality similar to Facebook functionality under alternate names.

Many of the Agora options described in this invention will operate better if the Agora users agree to set at least some of their social network privacy options at a lower level. In general Agora will be designed to operate at multiple social network privacy settings, inform users as to their privacy settings as the user desires, and also to suggest privacy settings that attempt to strike a balance between the user needs to expand his or her social network, and the user's competing needs for certain levels of privacy. Depending upon the event, some events may have present minimum privacy settings, while others will allow all privacy levels to attend. For the purposes of the various examples and embodiments discussed in this disclosure, it is assumed that all users have their privacy settings set to the lowest level, at least for the duration of the Agora event.

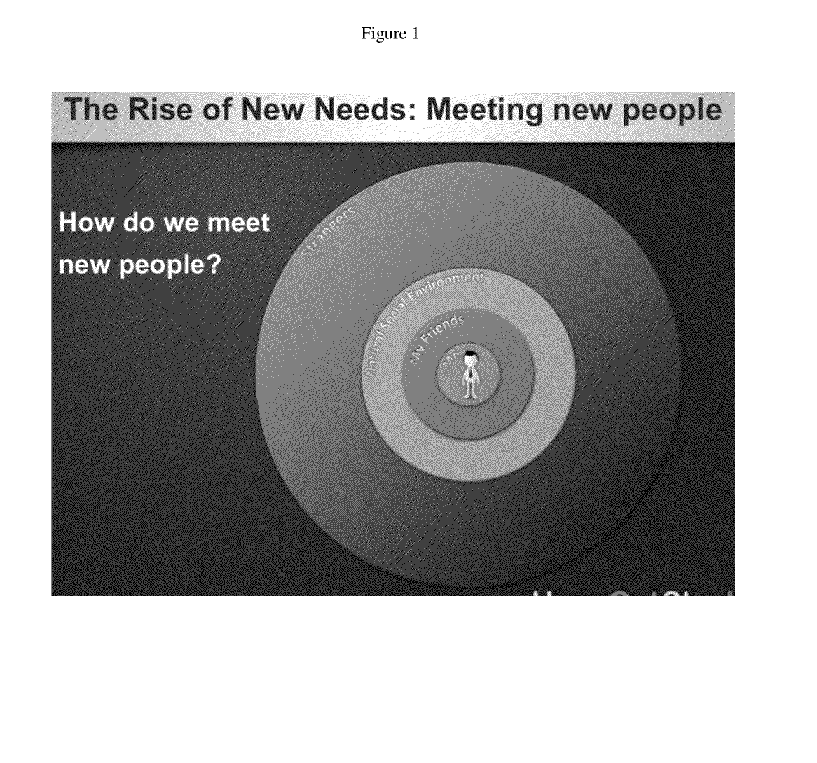

FIG. 1 shows the basic social model behind much of the Agora. This model of social interactions assumes that any individual's real-world social universe consists of first himself or herself, followed by a layer of friends and trusted associates that the user knows directly. In a social network, this layer is typically called a “Friends” layer. Surrounding this “friends” layer is the user's natural social environment, which will normally consist of associates or friends of the user's friends. In social network terminology, this second layer is typically called a “Friends of Friends layer”, which is distant from the user by at least one degree of separation. This second layer can occasionally also contain more remote acquaintances connected to the use by two degrees of separation. Although in the real world, of course, sometimes total strangers can meet and form a close relationship, on a statistical basis, most of the time that an individual meets new people in the real world, the new people are separated from the individual by only one or two degrees of social separation. This relatively close relationship tends to foster trust and congeniality, because often the two “strangers” share a set of friends or acquaintances in common. Agora makes extensive use of the fact that this one or two degree of separation information can, given the proper privacy waivers, be extracted from pre-existing social networks.

FIG. 2 shows one embodiment of the main computer network and main components of the Agora architecture. These components include 1) an SOA Layer Cloud, which may handles all business logic, including but not only, handling Agora virtual events, handling users, handling mailboxes, DOS/FOF information and more; 2) one or more Gaming Servers, which may handle all interactions between users in the rooms, for example: user moves, user talks, and other functions; 3) a SON Engine, which may be responsible for all interactions with external social networks like Facebook, Twitter, MySpace and other networks. Here the SON Engine can be designed to handle support for various social networks as plugins, so that additional social networks can be easily added to the system; 4) a Persistence Layer, which may act as the system Relational Database RDBS system, and may, for example, for scalability and availability, be based on shard MySQL instances or other database method; 5) a Caching layer, here, for example, the caching layer may be in a memory distributed Java environment, where each node has backup on at least on other node. Here all data may be kept in memory (e.g. system RAM) as long as possible. Thus data in the cache may persist in the persistence layer asynchronously, and may be read from the database when it doesn't synchronously exist in cache; 6) a CDN (content distribution network)—here the system static data may be kept in an external CDN service; and 7) an Analytics Engine, which may read data from the cache, and run analytics calculations on the Agora data.

All components may be monitored by central applicative monitoring and managing software with special features dedicated to the Agora environment. The various software components can usually scale exponentially (some can scale linearly). All component configurations can be dynamically changed by the Agora monitoring and managing system. In certain cases, the Google MapReduce software framework methods, as exemplified by U.S. Pat. No. 7,650,331, the contents of which are incorporated herein by reference, were used. See appendix 1 for further information.

First Innovation: Creating a Social Interaction Platform, Layered Over a Social Network

The operating philosophy behind the software design and functionality of Agora is that Agora should mimic many aspects of real life. Indeed, the default Agora software design assumption, unless otherwise stated, is that the various software features in Agora will mimic real life as closely as possible in Agora's Internet based, graphical user interface (GUI) platform. Users will generally interact with Agora using the same standard web browsers that they use to interact with Facebook and other social networks. Indeed, often Agora will be accessed and viewed within the context of a social network interface and web page.

Thus in the preferred embodiment, and contrary to prior art virtual worlds which create new virtual networks where users play characters other than themselves, Agora relies on one or more social networks (such as Facebook) to provide Agora with a real-life user base, where the user Avatar is taken from the user's social network information (e.g. photo, user identification, user supplemental information, user friends, user friends of friends, and so on). In Agora, users do play characters that resemble themselves, or expressed alternatively, since they are portrayed by their real social network profile, the users “come as themselves”.

The first innovation is implemented as follows:

1. Detaching the user base from the virtual world

As previously discussed, unlike prior art virtual worlds that maintain their own user base were users invent new identities, or that their users utilize to create made-up new identities, Agora relies on existing real social networks for a user base. Moreover, Agora intentionally preserves the real-life identities of the users, as reflected in their social network profiles, and uses this real world identity information to represent users in Agora's various virtual social events.

Additionally, Agora provides users with virtual social events that are much more suitable for solving the general problem of “meeting new people that are relevant to my real-life”.

The solution Agora provides includes a software methodology and data structure that enables Agora's system to be run as a layer easily placed over any social network. Further, Agora's methods represent Agora's users in a virtual social event as avatars that “carry” their previously established social profile, as well as providing graphical methods for accessing these user social profiles from within the Agora event without leaving it.

By contrast, although prior art Facebook applications may use Facebook's user base, these prior art applications added another layer of user profiles over the Facebook layer, thus tending to shield the user's Facebook social profile, or at least rendering the user's Facebook profile difficult and cumbersome to access.

2. Merging events: A method for merging two separate virtual events

As in real life, the success of many virtual social events, in the eyes of its guests, is often measured by turnout—i.e. the number of guests, as well as the level of entertainment and excitement they provide. Thus rather than hosting having many small events, often it is better merge the smaller events into a smaller number of larger events, because this way, with the larger turnout, the chances of making a new and useful social connection in any given period of time become much better.

Here Agora provides an option to allow event creators to merge two related events. This helps the event creator either revive an event that is suffering because too few individuals have signed up, or alternatively improve the turnout of an ongoing event by easily increasing the guest list of potential participants and inviting them. Thus Agora is designed to use meta-data from smaller separate events to create a larger combined event. This option allows the current participants of the events to be informed of the virtual event union. Agora also can preserve existing conversations from the various smaller events after the merger is done, and continue to make these accessible to the larger event if desired.

Second Innovation: Helping the User Make New Acquaintances Significant to his/her Real Life

Agora enables a virtual gathering of real-life social circles. Agora is designed to encourage geographically based virtual events, as well as offering user gatherings that match the user's social and geographical profile. For example, Agora may first offer a user from New York a list of virtual Agora events selected from events where the guest list is compiled mostly from people from the New York area, such as Manhattan, and which preferably may already have a few of the user's local friends already attending. The goal here is to make Agora events a fertile ground for making new, real-life, relationships, and this is facilitated by making new virtual contacts that are physically located close to the user's real-life location. Users are free to specify other locations, as desired, so that a traveling user, or a user intending to move into a new area, can inform the system to override the default geographic preference, and instead prefer an alternate designated location.

An essential component in achieving this goal is bringing down the “friendship wall” that is at the heart of social networks. At present, social networks are designed so that in general, only direct friends of the user can properly interact with a user. Agora's vision of event based privacy will help connect people from outside the user's immediate social belt, providing a virtual event framework that allows all event participants to interact, regardless of their “friendship status”. To do this, while maintaining privacy where desired, Agora may offer either various Agora custom privacy options, such as restrict to certain parts of the social profile being visible in the event, restrict to Facebook privacy settings, restrict to friends only (or to friends of friends only, friends of friends of friends only . . . ), and other options including options such as an “all may join” option or “all may see my full profile” option. In any case, these privacy settings will remain active only in Agora events, not affecting the privacy settings imposed on Facebook itself.

To facilitate new social interactions, Agora offer a novel type of “GeoChat” option:

3. GeoChat: Proximity based multiple conversations in a semi-realistic virtual environment.

Agora provides a virtual world environment that, like the real world, permits and indeed encourages proximity based group conversations (GeoChats). In the GeoChat option, a group of user avatars, when engaged in conversation, are shown in the user GUI as standing close to one another and facing the center of the conversation. Here the system automatically selects the participants of the conversation based on their proximity to the conversation initiator. In addition, the sequence of joining an existing conversation depends on the type of conversation, public or private, thus moderating the level of control that current participants of the conversation have over the conversation.

Furthermore, Agora allows users to partake in multiple conversations (rather than just being present in one GeoChat).

As in real life, the space that the conversations take place in imposes restrictions on them. For example, though standing right 10 inches from each other, separated by a wall, two people will not be able to converse. The Agora GeoChat algorithm takes into account the physical structure of the room in order to mimic this behavior, making for a more interesting and realistic conversation environment.

4. Agora also features dynamic avatar marking.

Attending a social event is in many ways similar to navigating through unfamiliar territory. That is, a real-world social event is often a sea of both familiar and unfamiliar people. Virtual social events are no different. A user enters an event as his or her avatar, intending to make new friends, have interesting conversations, find a new job opportunity, or meet the boy/girl of his/her dreams. However, even when the avatars may display social network identifying information, such as associated social network profile pictures, trying to distinguish between the various online avatars to find the right people behind them takes time and effort, particularly in a crowded virtual room.

Agora provides an option, here called “user goggles” to help the user see the virtual event crowd in a way suited for achieving his goals. User goggles are an avatar accessory (in the form of software that may optionally show the appearance of goggles/glasses on the user's avatar, or may simply provide the information to the user without altering the appearance of the user's avatar), that may either be worn by the user's avatar in the virtual event, or alternatively not be worn by the avatar but simply show the information on the user's GUI. The user goggle software acts to dynamically categorize the virtual event inhabitants (avatars) according to different categorization algorithms.

For example, by using the “social circles goggles”, the user's friends, friends of friends and complete strangers can be marked in different colors. Alternatively, by switching to an alternate “Singles night goggles”, the avatars of boys/girls in the user's preferred age group (as determined by stated social network age data) and/or that have a social network status of “single” may be marked differently than avatars.

5. Comfort zone: A method for placing a new guest in a virtual social event

When we enter alone into a real social event, we usually look for someone we know to stand next to or join in conversation. A similar situation occurs in virtual social events, because there a user almost always enters an event by himself or herself, and the system needs to decide where to place the user's avatar. Agora software acts to place the user's avatar in an environment where the user feels most comfortable. These areas are called “comfort zones”—areas within the graphical representation of the social event, containing other user's avatars, where the new (entering) user's avatar is most likely to encounter a favorable social environment.

The solution Agora provides for this problem is a method or algorithm for dividing the virtual event into “comfort zones”. The software implemented method calculates a comfort zone's level based on parameters like the number of degrees of social separation (i.e. are the other avatars in the virtual room the user's friends, friends of friends, and so on), number of conversations previously held with users in previous Agora events, social network joint interests and so on. The Agora software and method generally attempts to place the user's avatar in the “comfort zone” most suitable for him, unless the user wishes to select a different option. As a default, if the user has been invited by another user already present in that particular environment, the new arrival's avatar may appear fairly close in location to the avatar belonging to the invitee.

6. Graffiti wall: A virtual graffiti wall accessible to users attending a virtual event

Agora also provides a virtual graffiti wall, particularly useful for virtual events held in isometric surroundings, that provides an interactive way for all event participants to communicate with each other. Every user attending the virtual event can write on the wall, respond to messages written by others, or simply view the entire written message by simply by clicking on the wall, causing a window to be opened up that shows the messages more clearly.

In addition to adding an open communication channel among the attendees of the virtual event, Agora also provides a two way communication link between users inside and outside the event. This is done by linking the graffiti wall to, for example, standard Facebook social network message “walls” outside the Agora event. There event “outsiders” (that is social network users who may not have attended the Agora virtual event) can see the wall, and respond to at least some of the messages written on it.

7. Mini profile: A method for presenting a social profile inside a virtual social event

One key benefit of Agora is that it allows users to rapidly identify real life individuals that they may wish to interact with in the future. Here it is useful to give the users rapid access to the social profiles belonging to the avatars of other users that are attending a particular virtual event. Another aspect of this feature is that by utilizing the more relaxed privacy settings that the various Agora users attending an event may have previously agreed to, a person attending an Agora event can thus easily access the social network profile of another user attending the same event. This is another example of how Agora naturally “brings down the friendship wall”.

Here Agora's algorithms and software methods can summarize the data from a user's social network profile page and allow other virtual event users (avatars) access to it (at least as authorized), from inside an Agora virtual event (that is without leaving the GUI display of the Agora virtual event). To do this, Agora displays a space efficient “mini profile” of social network data that can show basic user details, basic user photos, mutual friends and so on. This way other user with avatars present at the Agora virtual event can easily access this data, and determine if further interactions might be in the mutual interest of both parties.

Agora also describes the manner in which a user may access this mini profile of another from the virtual event, and the graphical way in which it is displayed. Here a standardized Agora interface can be used that provides a similar appearance across multiple social network platforms, or alternatively, and to the extent permitted by any particular host social network, the Agora mini-profile may mimic the appearance of that particular social network's interface.

8. “20 second date”—Simulating a virtual date between users

Attending a social event and meeting someone new, breaking the ice and maintaining a rich conversation are not trivial tasks. Agora's “20 second date” option (which need not be literally 20 seconds, but which may have variable duration which may be adjusted by the system administrators based on user feedback) is a sped up date simulation for two users. Here the software may optionally provide both something to look at, and a conversation topic. Alternatively, such is in a business or conference setting, a neutral environment, such as a virtual conference table, may be provided.

For example, Agora may put the user's avatars into a new virtual date environment or screen partition, which optionally may be made visually interesting—i.e. an exotic scene, which may or may not be realistic. For example, two users who both list “astronomy” on their social network Facebook pages may, for example, be given a virtual date environment set on the moon, while others who indicate travel as a common interest may be given a virtual date environment set next to the Eiffel tower.

Typically this option is initiated by one of the conversing users. When activated, the system puts the users' avatar through a mock date animation, and displays it to the two users at the same time. The short time window encourages participation, and this time window may be extended by consent of both users as desired.

9. Speed chat: a “Semi-random” time restricted chat session within a social event

This option is similar to the speed dating concept of time constrained “random” dates, except that the simulated environment may be less romantic and more business-like.

10. Virtual cell phone: A software virtual “apparatus” for managing contact messages and notifications in a virtual world

In some embodiments, Agora may introduce a virtual cell phone interface into its virtual environment. This virtual cell phone device will allow a user, while operating in a virtual world, to send and receive messages, notifications and reminders on upcoming events as well as manage his contacts. By providing an interface that mimics a real-world cell phone, users may find the process more realistic and immersive. At the same time, the real world manufacturer of that particular cell phone may be happy to sponsor the virtual cell phone as essentially a type of product placement advertisement, and this will help generate revenues for the system.

In one embodiment, the virtual cell phone may be shown in the Agora GUI as always “on the user”, no matter where the user is in the application. This will allowing the user to communicate with other users at all times via texts, and may save these messages in an inbox for when the user is not logged in.

Third embodiment of the invention: Virtual events guide

Agora's Virtual Events Guide, or “smart-guide”, allows Agora's subscribers to find out what is going on in their virtual social environment. This guide can list the events that are “hot and happening now”, future events, as well as provide a magazine-like summary of past events (including pictures, highlights and gossip). The smart-guide may additionally implement prediction algorithms to show Agora's users the virtual Agora events they are most likely want to take part in. In essence, this approach introduces new terminology into the social network experience, as users ask themselves: “Where are my friends hanging out? What are my friends doing right now? Where should I go . . . ?”

This virtual guide may comprise various functions, such as:

11. TimeOut: A virtual events portal and search engine

As time spent in virtual events increases, and the number of virtual events increases, the problem of finding the most interesting virtual social events, and managing the various virtual social events, starts to grow in importance. Here the Agora system may also provide the tools for creating, managing and finding virtual events that are not unlike the event management tools that are used to handle real events.

For example, the Agora TimeOut functionality may provide an environment that may comprise the following components:

11(1). Virtual event creator—Choosing a location for a virtual event, defining a guest list, accessorizing the event.

11(2). Virtual event finder—A search engine for virtual events, with an event rank algorithm that may be set to be specific (e.g. customized) to that particular user.

11(3). Offered virtual event—Automatic event recommendation algorithms based on the event's guest list, location, type and other parameters. Again the system may automatically rank these events in a way that may be user customized or specific.

11(4). Managing event invitations—Tools for receiving notifications on starting events, new event invitations and managing RSVP status for the user's events.

11(5). Event analytics—Statistical information measuring the success of the virtual event (money spent by guests, number of attendants, RSVP status, number of conversations, and so on).

Agora may provide data giving additional information on the types of virtual events supported the information presented on each of them; the various use scenarios for creating, searching and joining events, as well as extending invitations to other users.

12. Where are my friends? A method for presenting events that the social network friends of the user are attending.

One of the most important questions that a user may ask when deciding how to spend time or “hangout” online is: “Where are my social network friends and what are they doing?”

In this embodiment, Agora works according to the rule: “Tell me where your friends are and I'll tell you where you will likely want to (virtually) go”.

Here Agora presents the user with a list of virtual events that the user's friends (as defined in his social network profile) are currently attending. The system may also show what their friend's avatar is inside the virtual event. Thus if the friend's avatar is talking, a talk balloon may be shown, and so on. The this feature allows a user to quickly search for the virtual social event where a specific friend is currently “hanging” and allows the user to quickly join his friends in the virtual events that they are attending.

Another embodiment of the Agora invention is a method or algorithm of prioritizing future events.

13. Virtual event Priority algorithm: A method for prioritizing virtual social events offered to a member of a social network

Here Agora may provide a search engine that produces, as a result, a set of virtual events that are likely to be most relevant to a user. This requires that the system automatically prioritize various virtual events according to preset or user selected parameters.

Agora's virtual event search method or algorithm takes into account various sets of search filters according to the following information about the user and the various events. These search filters can categorize the search according to various user selected parameters. Although in the following example, the parameters are grouped into “high”, “medium” and “low priority”, in many embodiments the user will be able to determine the priority weight of the various parameters, and thus the following parameters and ranking are given for example purposes, and are not intended to be limiting.

High Priority Parameters:
Event status—Live events have priority over upcoming events, which in turn have priority over past or canceled events
Current event participants list—this can include the number of attending members from the users “Entourage” (a smaller, more important subset of the user's friends, chosen by the user) and total number of the user's attending friends. The Agora “entourage” can either be set by the user as that subset of the user's friends that the user would most like to invite to events, or alternatively can be automatically selected by the Agora system based upon the user's past history of attending virtual events with certain social network friends. Here the user's “entourage” friends are given a higher weight, but the total weight to any event will go up as a function of both the number of entourage friends and regular (e.g. regular social network friends not designated as being in the user's entourage) attending friends.
Current event size—this calculation is a function of the number of current participants versus event capacity in terms of total number of allowed participants. Here the closer the event is to full capacity, the better.
“My favorite reoccurring events”—The highest priority will often be given to the list of reoccurring events that the user has subscribed to.

Medium Priority Parameters:
The ratio of event Friends/to event Strangers and/or the ratio of event (Friends of Friends+Friends)/Strangers
The number of people that the user has previously met in other online parties.
The ratio between the number of people coming from distant locations, versus the number of people that are coming from the user's current or designated location. Here the system will usually build in a preference for local people.
The number of people in the user's age group. Here again, the default preference will generally be for people that are near the user's own age.
Reoccurring events that the user has been to previously
Reoccurring events that the user has given high ratings to
A system place ranking, which may be set by the judgment of the system administrators, or on other automated factors and algorithms such as overall user feedback ratings, user complaints, length of average user stay, and the like.

Lower Priority Parameters:
Events in the user's area
Locations that the user has been too before and given lower ratings to.
Type of events that the user likes
Event creators that the user likes

These and other parameters can then be used in a search algorithm to rank and present virtual events customized to the interests of various users.

Other useful methods and algorithms produced by the Agora search system include methods for ranking virtual social events according to some sort of desirability parameter. These methods include:

14. Engage-gage algorithm: A method for calculating a virtual social event's liveliness and friendliness

How engaging a social event is (i.e. how lively the event is, and how open are its guests are to conversations) can be an integral part in predicting a guest's expected level of satisfaction. This factor becomes even more important for users who are trying to decide if they should attend a strange social event (i.e. one where none of the user's friends may be attending).

Agora may optionally rank the level of event “engagement” according to the following parameters:

14(1). Degree of separation aggregation—A weighted function of the user's number of friends, and friends of friends, combined with recent interactions the user had with them on the social network. Here the more friends and the more recent the interaction, the better.

14(2). Conversational behavior of current participants—Number of conversations held in the event since it started, their sizes, how dynamic and open they were (in allowing new chat participants to join in), degree of separation within chats.

14(3). Previous conversation history between the user and any of the current participants—Does the event contain guests that the Agora user has already talked to in previous events?

14(4). Comfort zone calculation on the event level (previously discussed)

14(5). Number of participants to available room space ratio: if a virtual “room” is too crowded, this may be undesirable; however a very empty room may not be too good either.

14(6). Idle time detection—A measure of amount of time users attending the event spend not engaged in activity with others.

To provide further explanation, these and other Agora aspects will now be discussed in further detail.

As previously discussed, throughout this discussion, many of the examples will be based on an Agora implementation designed to run within the Facebook social network. Thus in the specific figures that will be provided shortly, in order to emphasize the fact that the Agora application can be set to run within a particular social networks user interface, the color scheme of the Agora interface has been set to match the color scheme of this particular social network, here Facebook. In practice, however, the color scheme and layout of the Agora interface may, in fact, be tuned differently so that while the Agora application will still be running within the particular social network, the Agora color scheme and layout may instead be set to a different color scheme, which may be proprietary to Agora, to enable the users to more clearly understand when they are running an Agora application, and also potentially to preserve a uniform Agora appearance across multiple social networks. Indeed, with proper interface designs, users from one social network may meet users from another social network in the same Agora interface, and interact with them simultaneously.

In the following examples, the figures shown represent actual screen shots of a demonstration Agora application running within a demonstration Facebook application. Here both the Facebook and Agora interface may, for example, run in the GUI of a user's web browser. In the following examples, in many cases, in order to show more detail, portions of the screen showing aspects of particular interest will be shown in higher magnification.

Live Event Features:

Features listed in this section are the ones that provide the rich interactive environment for holding an Agora social event. Although other methods of rendering the social event environment, such as a 3D first person perspective, a 3D from above and behind the user perspective, and other perspectives may be used, in some applications, in order to reduce the amount of computation required, there are some advantages of representing the social event environment from the standpoint of a 2D isometric environment, and in this disclosure, this 2D isometric environment rendering method is used for these examples. Regardless of the environment rending method, in all cases, the environment will generally be filled with responsive virtual items, and avatars representing real people (with data taken from the associated social network). The rendering will show the interactions between two or more users, as well as notifications (often written, but occasionally verbal or icon based) that the system will send telling the user(s) about various interesting things that are happening in the event.

Virtual events in Agora can be very dynamic. This is because the event guest list can change while the event is ongoing. That is, event users are allowed to move around between virtual events as they please, and the event creators are also allowed to pick and merge different events together into a single larger “mega-event”. These dynamic events can be further facilitated by the following Agora features and functions:

1) Modify the location and features of a live event—An event creator can monitor an ongoing event, and based on the event feedback can add/remove items to the event, change the virtual event location, integrate new social games into the event, and make other real-time modifications as the creator's judgment dictates.

2) Invite people to a live event—Here any participant of the virtual event, or alternatively a subset of participants as designated by the event creator, can invite his friends over to the virtual event, without leaving the virtual event. Here, again using the Facebook social network as an example, depending on the “Facebook presence” of the friend (i.e. is the friend currently connected to Facebook, or Facebook chat, or attending some other Agora event or even disconnected from Facebook altogether); the Agora system will offer the right communication channels to allow the user to contact his or her friend. Thus the Agora system may provide the interfaces and links to allow a user to contact a friend by writing a message within the context of that particular social network system (e.g. write a message to the friend's Facebook wall) or alternatively provide the interfaces and links to allow the user to contact a friend who is not currently on a social network, such as by sending the friend a cell phone SMS message or an Internet Messenger (IM), message, as well as other alternate message modalities. Typically the user will use this interface to send his or her friend an invitation to attend the ongoing Agora event.

3) Merge events—As previously discussed, event creators wanting to “double the fun” generated by their event can decide to merge two different ongoing virtual events into one, thus instantly refreshing the guest list and mixing things up. Thus two class parties from the same school and year, for example, can be combined to create one larger class party.

As previously discussed, navigating the social seas isn't an easy task. Agora events also support the user with various methods and interfaces to help find the right people to interact with. Additional information on some of these functions is shown in the following implementations and examples.

4) Access event details from the live event—A user attending a virtual social event can access its details (e.g. current guest list, event type, where are the people coming from, what ages are they, who is the event creator, etc.) without leaving the live virtual event.

5) Interactive guest list—This virtual event guest list, in addition to being visible to users attending the live event, can also be used as a navigation tool to allow the user to make his avatar “go to” one of the event participants without having to spend time searching for the other participant on a screen depicting the event. In addition, the user can open a mini-social network interface, such as a mini-Facebook profile page, of any of the participants in the event and see the profile information about the user as authorized by the user. Here often in order to attend an event, the users may be required to authorize at least some friends-of-friends or more viewing of at least some of their social network information.

6) Access social network information about a guest—Since Agora relies on a social network to provide it with a user base, accessing the social profile of an event participant without leaving the virtual event screen is integral to the event experience. In Agora, any user in the event can click on another's avatar and access his or her social profile. In order to access more content about the other user than the other user's social network privacy setting would normally allow, users will be encouraged by the system to at least temporarily lower their privacy settings for the duration of their participation in the Agora virtual event. Such privacy modifications will generally be clearly shown to the users, and the default behavior will be to return to the previous privacy setting once that particular Agora virtual social event is over.

The social profile presented by Agora will typically be an aggregation of the most interesting information within the user's social network profile and also will often allows access at least some of the user's photo albums. As previously discussed, the specific examples shown here assume that at least for the temporary duration of the event, the various participants privacy settings have been set to a lower level. Indeed Agora may work with the social network administrators to enable various functions such as allowing a user to dynamically change their privacy levels for purposes of attending an Agora event, followed by automatic restoration to the user's previously set privacy level once the event is over. Alternatively, Agora may work with the social network API to request user permissions for using the content. This method allows Agora to create a different privacy setting that applies only for the Agora event, while the regular social network settings may remain the same outside of the Agora event or application.

7) Profile the user as an avatar—The user's avatar in Agora is basically a physical representation of the social profile of the user. Such avatars may be designed to be relatively minimal and faceless, generally only conveying the user's sex (e.g. the Avatar may look like a stylized man or woman), carrying the user's profile picture for identification. Such avatar uniformity, although not required by the invention, is useful because this focuses the user's attention onto the Facebook profile picture, rather than the avatar itself. Clicking on one such avatar will usually open the attached user mini profile, compiled from the user's social network data.

8) Distinguish between event participants (user Goggles)—As previously discussed, while attending a live Agora event, the Agora system may automatically mark the user's friends, friends of friends and the rest of the crowd with different colors. The idea behind this feature is to allow the user to distinguish between, for example, different event participants by such variables as the participant's ages, people he already conversed with and so on.

At their heart, Agora events are meant to encourage interactions among users. Combined with the fact that events are created by users with their initial “friends” guest list of generally more trusted individuals, this provides for a rich environment for creating new meaningful connections.

9) Visual isometric environment for a virtual event—as previously discussed, although Agora events may be shown from various perspectives, e.g. 2D, 3D first person, 3D behind and above first person, and so on, in a preferred embodiment, an Agora event may be conducted in a two dimensional isometric environment allowing users to walk around, see each other and interact. This 2D virtual environment provides much of the realism of a 3D virtual environment, but is computationally less intensive.

10) Interactive room objects—Many or all virtual items integrated into an Agora event as room objects may be interactive. Some of these items may be objects that the user's avatar can interact with (e.g. sitting places such as couches, chairs or bar stools, leaning places such as the edge of a bar, lying places such as hammocks or a beach towel). Other items may be objects that the avatar can pick up and carry around such as glasses, a single red rose and so on. Still other objects may hide or contain additional Agora applications inside the object. For example, a jukebox object may contain music, which may be selected for playing in the event. As another example, a pool table may contain pool balls and pole cues which may be in turn used when a user plays pool with another user. When an Agora object contains another object or function, generally and clicking on the object in the Agora GUI will often open up a new interface or interaction environment.

Agora users may indicate if they “like” a particular object, and other Agora users may in turn see which users like a particular object. Thus a pool player can “like” the pool table, and other Agora users, knowing this, can invite the user to play pool. In some embodiments, with appropriate user permission, “liking” an object can also add a link to the object on the user's social network profile page.

11) Interact with other users—A user attending an Agora event can choose from a variety of interaction mechanisms with other guests. In addition to simply chatting (as described in the following bullet), guests can dance together, kiss each other, greet and wave, or send Agora texts to one another (in the form of virtual SMSs reaching a virtual cellular phone). Generally this interaction will be visible to at least the other user, and often by the other Agora guests present at the event as well.

12) Conduct group chats—The chatting experience in Agora is intended to resemble real life conversation, and forming new chats is meant to be as natural as possible. For these reasons, chatting in Agora is proximity based. Here users need to stand close to one another in order to be able to talk. Chats are conducted in chat spaces, generally a designated sub-window in the Agora GUI which may, with appropriate permissions, be designed to resemble common chat interfaces e.g. mimic the appearance of “Google talk” or “Skype”, and optionally also allow users to integrate rich media (photos, emoticons, videos) into the conversation. Agora may additionally support group chats as well, thus allowing users to participate in more than one conversation at the same time. As previously discussed, this group chat may be an audio chat as well, and here Agora will work with the user's audio equipment (e.g. microphone, earphones, audio headset) as needed.

The Agora GUI may often also show which users are engaged in conversations by, for example, showing an icon of a conversation in progress balloon or other visual display. These “conversation in progress” markers will generally be visible to all the event's guests so that other users can try and join the conversation in progress. Generally however, the actual content of the conversations will be visible only to its current participants, although users may choose to allow some content, such as emoticons, to be seen by all users.

13) Integrated applications (apps)—As discussed previously, The Agora meeting GUI may also embed or integrate various other interaction applications hidden into various room items. These may include:

13(a). Graffiti wall—The graffiti wall allows guests of the same Agora event to communicate with each other by writing on a virtual wall integrated into the event. The wall itself may also visible on the event's page visible in the social network. People not in the event can reply to messages written from inside and vice-versa, creating a two way link to the “outside world”.

13(b). Photo slide show—The event creator can chose to embed a photo slideshow of the user's photo albums on the walls of the event. Guests can open these albums, flip through them, comment on photos and read other comments already made on them. Although this photo album may consist of photos uploaded specifically for this particular online event, often the photos will be taken from photos that the user has previously uploaded onto the social network, such as photos that the event creator has placed on his or her Facebook profile page.

13(c). Jukebox—The music played to all event participants may be initially chosen by the event creator, but the creator in turn may allow other users attending the event to control the “Jukebox”. Here other event users can add another song to the playlist, as well as buy song dedications to other guests. Such purchase can be by either a suitable micropayment method, free, or alternatively by Agora credits created for the particular event.

14) User controlled animated avatar—As previously discussed, the avatar representing the user is an animated character, often a stylized man or woman figure, that is able to walk around and approach other guests, dance, sit and stand, lean, lie down and perform many other animations. In a preferred embodiment, the user controls his or her avatar's behavior, and the user can also customize the avatar's appearance. Again, as previously discussed, in order to focus the attention of other users onto the social network profile associated with that particular avatar's master, often the avatars will often be kept relatively uniform and bland in appearance.

15) Shoot a picture—At any given time, the user sitting back home by his or her computer can shoot a “real emoticon” of his or her face using his or her webcam and broadcast this floating image to the entire crowd, or alternatively, in more computationally intensive 3D rendering environments, paste the emoticon of the user's face onto the face of the Avatar.

16) Make an announcement—The event creator can also make an announcement that may be “heard” (or at least seen, since often this will be in the form of text) by all event participants no matter what they are currently doing in the event. This “make an announcement” mechanism can also be exploited for allowing user to purchase the ability to grab the attention of the crowd if they wish to do so.

17) Event newsfeed—While attending the Agora event, the user may additionally receive notifications from the Agora system regarding various interesting things as they occur (For example, if our user invited someone to the event and this other person arrives, or one of the user's friends is dancing with another person and so on). This event newsfeed mechanism sends the user various types of notifications according to previously determined levels of interest. This helps insure that the user does not miss interesting events. For example, if a close friend of the user enters the event, the system will send a notification to the user, and the user will know to “go to” the just arrived friend if this action is desired.

Virtual Events Guide Features

As previously discussed, some of the features listed in this section are designed to make virtual events as “real” and as easy to find as real events. These features include user specific virtual events recommendations, a virtual events search engine and an environment to manage a users virtual events calendar and RSVPs.

Some of these features include:

18) Virtual events search engine—The virtual events search engine allows Agora users to more easily find the virtual events they are looking for. In addition to allowing users to search for virtual events based on the event properties and guest list, the Agora virtual event search engine also provides the user with a personal priority search algorithm that can be based various factors such as the particular user's relationship with or social network relation to the event creator, as well as the virtual event guest list (degrees of separation, past conversations conducted) and other parameters.

19) Offered events—In some embodiments, the Agora GUI may provide an events search engine interface that also automatically provides personalized event recommendations to the user. Here, the recommendations may revolve around mechanisms such as:

19(a). “Where are my friends?”—At any given time, the user can check and see where in Agora his friends are currently hanging out, and get a link to join them. Extending this feature, the user can also, with the other user's permission, choose to follow other users around from event to event. The Agora system can also present a user with the whereabouts of other users that the user previously talked to in other Agora events or on “Facebook”.

19(b). “Hot events happening now”—Here, upon entering the events guide, the user may be presented with a list of the top events, such as the top 10 events, that the Agora system presently has available to offer the user. These events will be selected from live or immediately upcoming events, and the search algorithm will attempt to provide events that have attendees that are most similar to the user's stated preference.

20) Personal banners—A user entering the event's guide may optionally be presented with personal banners prompting him to create events related to his friends. Examples of such personalized banners include text statements such as “Your best friend's birthday is coming up, create a birthday party for him on Agora!”, or prompts to invite the user to take a look at various new virtual items that the user might enjoy.

21) Advertizing platform for sponsored events—In addition to events created by users to enable the user to “hang out with their friends”, Agora also allows the creation of sponsored events, which can be promoted to other Agora users through the virtual events guide. These sponsored events may optionally be linked to real-world promotions, for example providing coupons or product price discounts to users that attend.

22) Virtual events manager—Often Agora users will wish to create their own virtual events, and invite their friends to join. To do this, Agora provides a virtual events manager interface. This virtual events manager interface allows a user to generate both planned and spontaneous events. To do this, the virtual events manager provides an interface to allow the user to design the location of the virtual event ‘room” (i.e. what location the room will preferentially attract users from), the appearance, features, and items within this event room, and also provide the appropriate level of integration required to integrate the social event planned for this room with the social network information contained on the relevant Agora social network, such as Facebook. Note that although the term “room” will be used throughout to designate the Agora meeting area, by suitable choice of wall imagery and wall positioning (i.e. distant walls), the room may in fact be made to simulate the appearance of an outdoors environment. Thus a virtual room could just as easily be a virtual sea shore or mountain meadow.

Some of the key features for this functionality include:

23) Create an event—As mentioned earlier, users and content providers can create virtual events in Agora. An event in Agora may come complete with guest list management tools, a virtual location where the event takes place, a schedule and entertainment integrated inside the event (in the form of social apps, music, photo slideshows and so on). The events created can be public events, where entry doesn't require an invitation or private events, where invitation is required. The events can also be either free or require a special entry fee. The events can also be either ad-hoc spontaneous events or recurring planned events.

As previously discussed, usually the guest list is based on the user base that provided by the Agora social network partner, increasing the chance that the events will introduce people who are relevant to one another.

24) Designing a hangout—Agora provides the user with a studio where he can design his own hangout place to use as a location for his events. The studio allows choosing the room structure and adding virtual items.

25) Integration with social networks—Agora can work with the dynamics of its partner social network to help create the “buzz” or publicity for any given virtual event. Here often the Agora event may be mirrored with an event on the social network. For example, again relying on Facebook as an example social network, an Agora event can automatically use the Facebook user base, and create a twin Facebook event to mimic or track the Agora event. When this option is chosen, the guest list may be set to be visible to other Facebook users, and can optionally also be extended from it. As a result, notifications that the Agora event is starting shortly can be sent as a “Facebook user to Facebook user” message, as well as being shown in the previously discussed Agora “Virtual Events Guide”. Further, in some options, changes made to either event (the Agora event or its Facebook twin event) can be reflected in both the Agora and Facebook interfaces. Cross social network communication can also be enabled by Agora so that, for example, an announcement of a Facebook based Agora virtual event could be announced over Twitter or other communications service.

Selling Virtual Items

In order to help monetize the Agora service, revenues may be obtained by several channels, including selling virtual goods. To do this, Agora may provide users with an option to purchase such virtual goods when it is appropriate (e.g. a virtual items store, personal user banners, inside event offers, jukebox songs, avatar appearances and so on), and may also showcase virtual items within the Agora application as well.

Some of the more sales related features include:

26) Buy another user something—For example, while attending an event, a user can purchase a virtual “drink” for another user to show interest, buy him or her a virtual “rose” or give him or her any number of other virtual gifts. Alternatively a user may choose to purchase these options for himself or herself. These virtual gifts include:

27) Customize the Avatar—This option allows the user to better express and differentiate himself from the crowd by offering him or garments and accessories for his or her avatar. For example, a male Agora user may decide to purchase a good looking virtual “tie”.

28) Design a hangout—An Agora event creator can choose to integrate virtual items in the room as desired for the event. Some of these virtual items may be standard “free” items, while other items may be available for extra cost. Some event locations may also be standard and free, while other locations may be premium locations also available for extra cost.

Examples of Agora in Operation are Shown in the Following Figures.

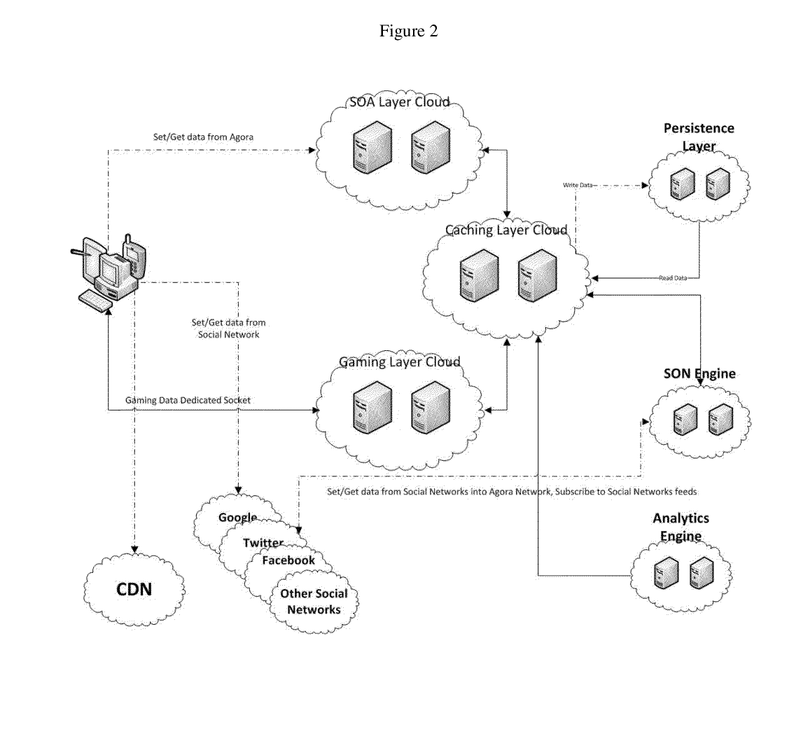

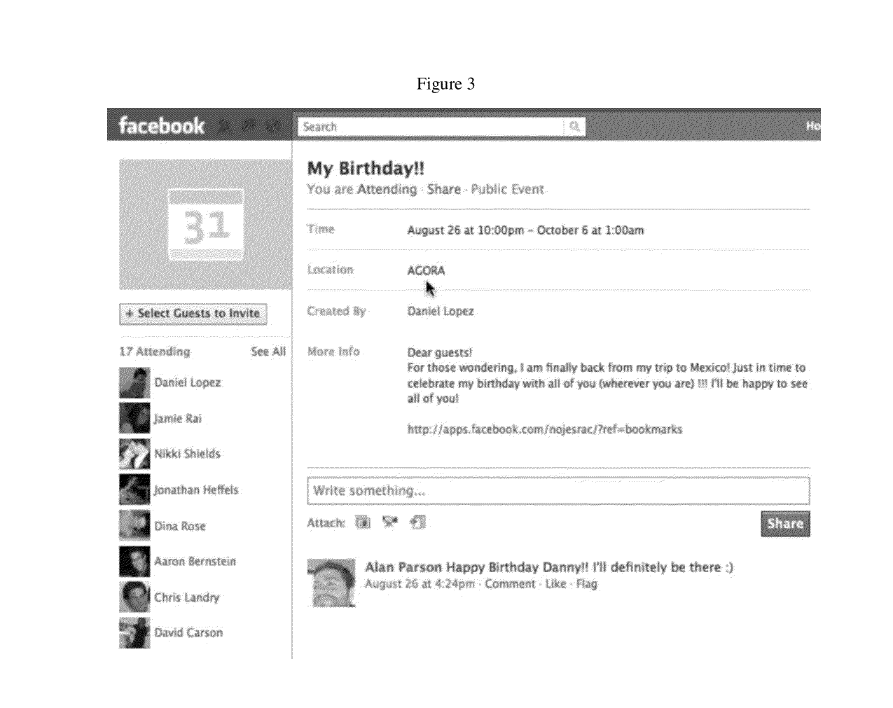

FIG. 3 shows an example of an Agora event, here shown embedded within a standard Facebook social network page. The link will take interested Facebook users to the Agora event. Here the type of event (a birthday), time of the event, Agora link, and who created the event are shown. The user is about to click on the link that opens up the Agora party interface page.

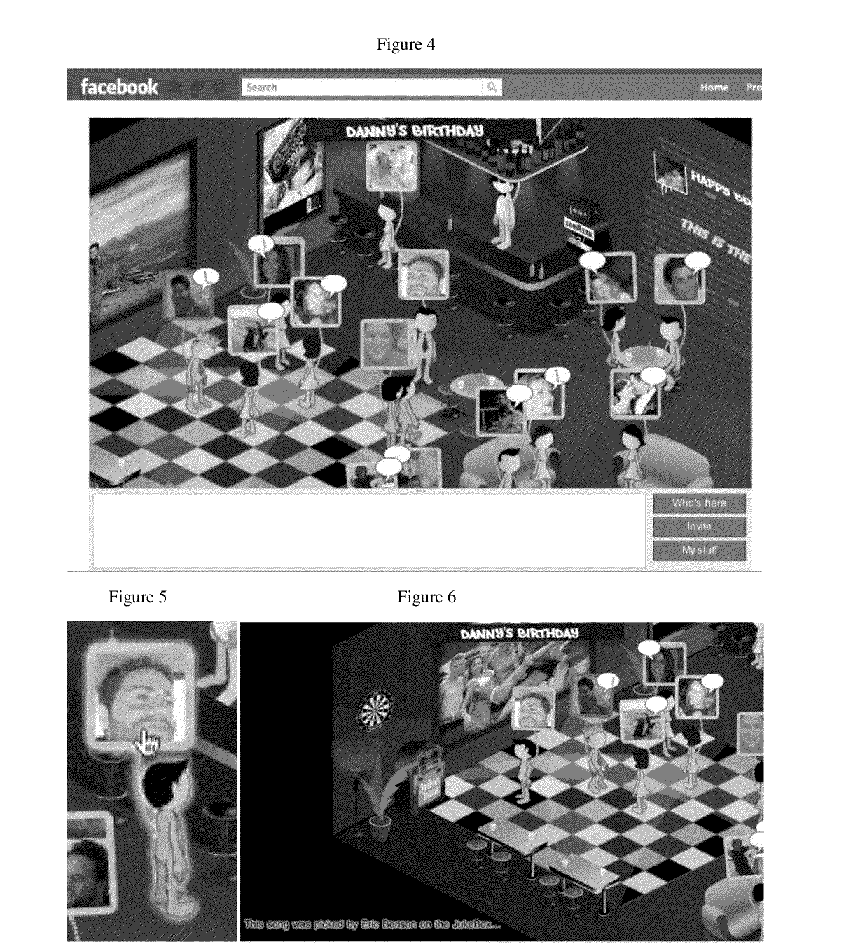

FIG. 4 shows a picture of the ongoing Agora virtual birthday party. Here various male and female avatars are shown interacting in a virtual bar setting, and the Facebook profile photos of the avatar's various real-world users are shown linked to the avatars.

FIG. 5 shows a close up of the user's avatar. This avatar represents the point of view of the user who has just clicked on the link in FIG. 3, and is also the main point of view for the purposes of this disclosure.

The other avatars represent other people who are present in the Agora virtual party in real time. Often the figures will be color coded. Thus, for example, figures may be color coded blue to represent the direct Facebook friends of the user from FIG. 5, while the indirect “Friends of Friends” of the user may be given a different color, such as yellow. By contrast, avatars being run by Facebook strangers to the user in FIG. 5 can be given a third color, such as gray.

As shown in FIG. 6, the users can usually command the avatars by mouse click or button push (or by finger swipe or even by hand motion or verbal command), to walk around the Agora virtual party (here shown in 2D isometric format). Just as in the real world, the Agora avatars can walk around, dance, chat, and go to the bar and have a “drink”. Here, even though the user from FIG. 5 has not yet joined a particular conversation, the user, although not able to see the details of the conversation, can at least see that others are talking to each other by way of their conversation balloons. Here, due to the previously described GeoChat feature, the conversing users are physically close to each other.

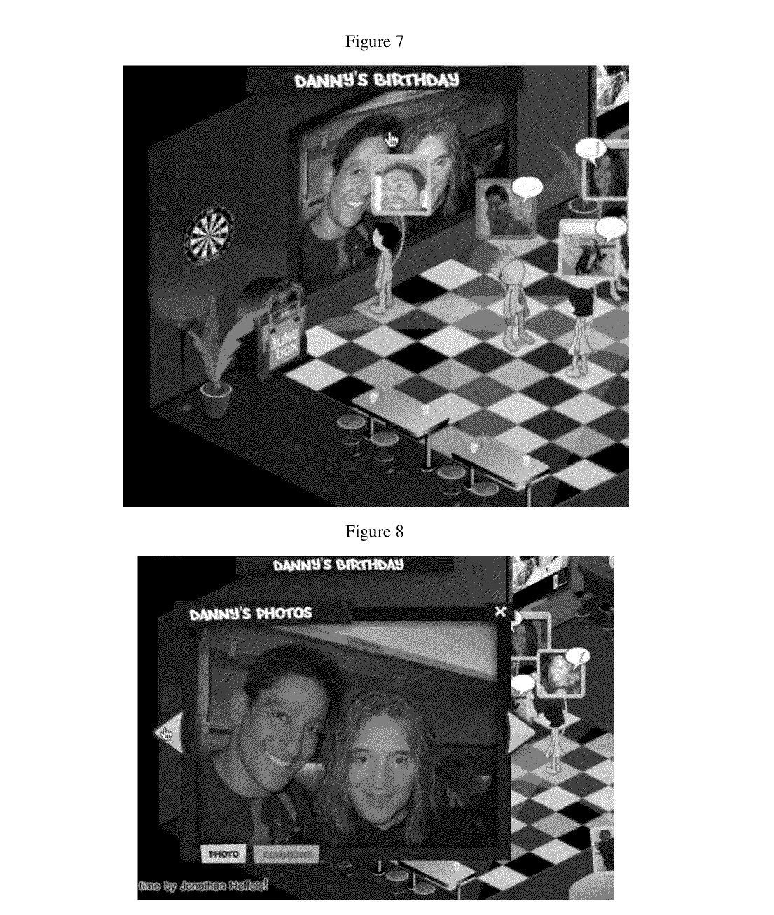

FIG. 7 shows a slideshow of pictures on the wall that the event creator has added or selected for the event. In this example, the user has selected photos taken from Danny (the birthday boys) Facebook albums.

FIG. 8 shows that by clicking on the picture on the wall, the user can see Danny's various Facebook photos in more detail, as well as additional hot spots (buttons) where the user may click to, for example, add comments to the displayed photo.

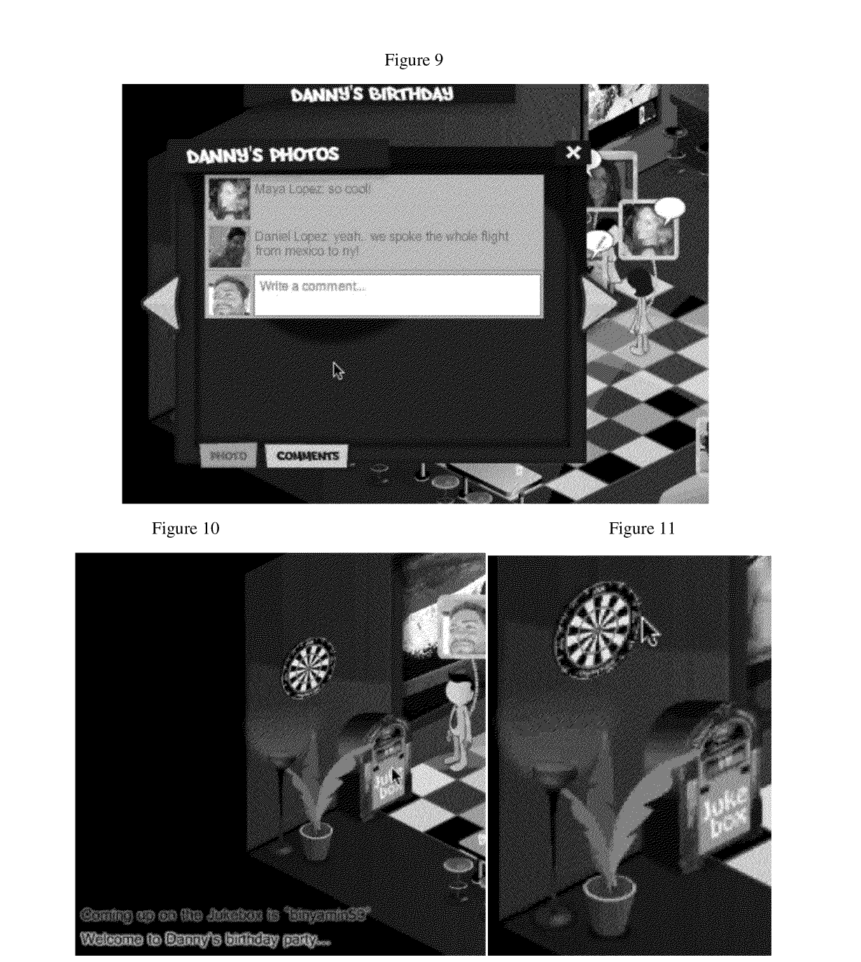

FIG. 9 shows what happens if the user clicks on the ‘add comments” hot spot or button from FIG. 8. The screen shows, still within the context of the online Agora virtual party, comments that previous users have entered in regarding that photo, as well as a place for the user to write his or her additional comments. Agora can maintain a two way link with the Facebook comments so that regular Facebook comments are reflected on the Agora game picture comments, and conversely the Agora game picture comments can be reflected in the regular Facebook comments.

Moving to other items in the room, FIG. 10 shows a corner of the Agora virtual room that contains a jukebox item. Clicking on this item allows the user to select a new song for the jukebox to play.

Everyone in the room sees the same picture and they hear the same sounds. By clicking the jukebox, the user can choose the next song, or dedicate the next song to someone, or even get information about the song that is currently playing, such as the song artist and title. In some embodiments, the jukebox may also contain a link to the music publisher or distributor so that the song can be purchased. Other Agora items may also have links to real world manufacturers or distributors of the corresponding items.

FIG. 11 shows an example of another virtual item, here a dartboard virtual game. Clicking on this item would allow a user to play a virtual dartboard game with another participant to this particular Agora party.

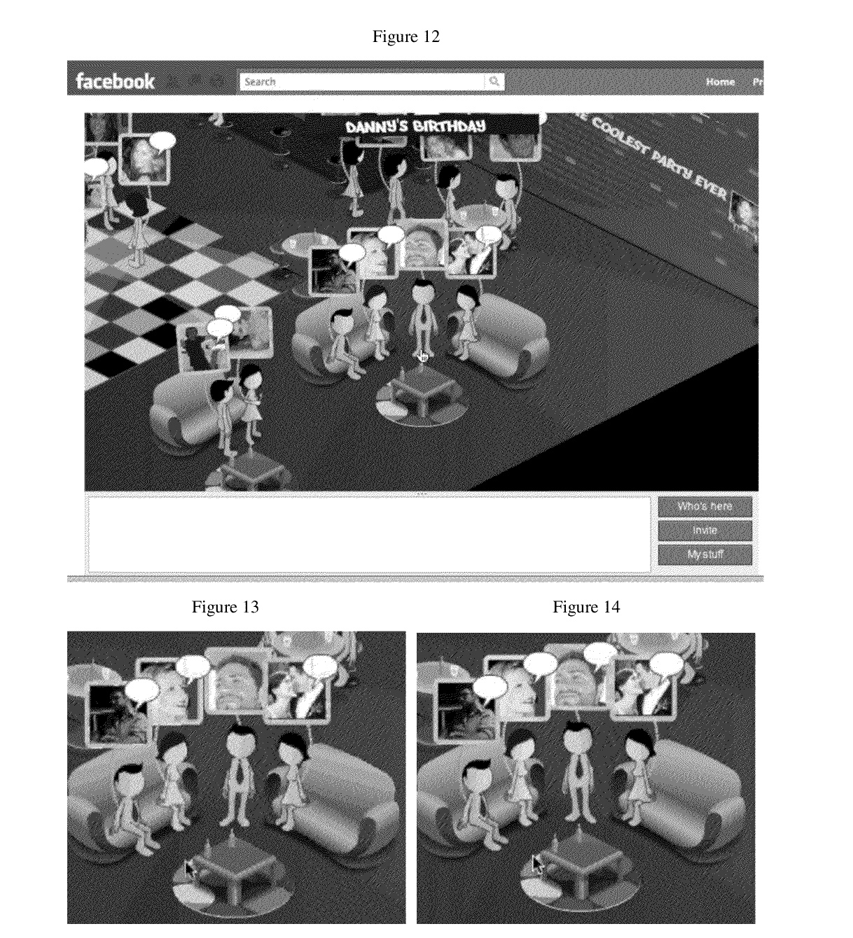

In FIG. 12, the user from FIG. 5 has now decided to join a group of other party participants. By looking at the color coded avatars, the user can tell at a glance which avatars correspond to the user's friends and friends of friends, and by inspecting the linked Facebook photos, the user can tell exactly which friends are controlling which avatar.

FIG. 13 and FIG. 14 show the GeoChat option in operation. In FIG. 13, the user from FIG. 5 is just slightly outside of the GeoChat sphere of influence, and although the user can see that the other members are chatting, he cannot see what they are saying, nor can the user himself participate.

However in FIG. 14, the user has stepped slightly close, just inside the GeoChat sphere of influence, and now GeoChat shows by a suitable icon, such as a talk balloon that has just appeared, that the user from FIG. 5 now can talk with the other local participants.

Conversations can occur in various types of chat boxes, such as the chat box shown at the bottom of FIG. 12, or other type of chat box.

Once the user has stepped close enough to the other participants, (e.g. FIG. 14), the user can now see the other user's comments in the chat box, and also enter his or her own comments. The chat box can also show exactly who is now participating in the conversation. This is shown at the bottom of FIG. 15.

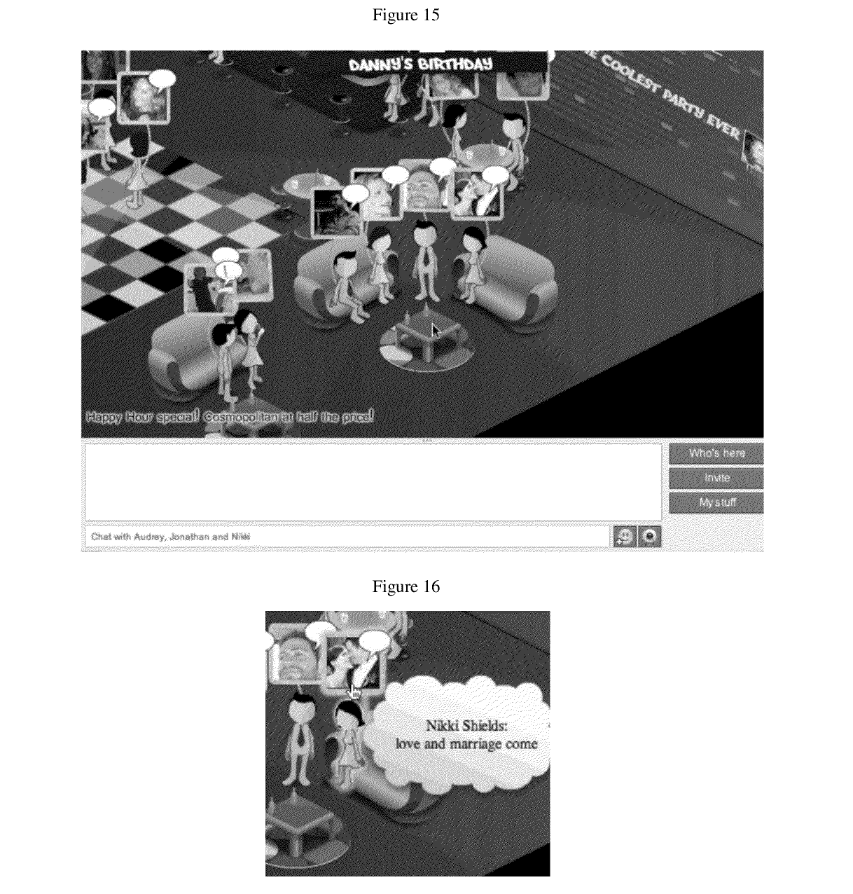

Note that in some embodiments, mousing (e.g. moving a mouse cursor) over (but not clicking) on an avatar can reveal information such as the tag line or Facebook Figure caption belonging to the owner of that particular avatar. In FIG. 16, the user has moved the mouse over a Facebook friend, and has discovered that she has likely recently become married.

By contrast, in FIG. 17, the user has now clicked on this other user's avatar, and the Agora interface shows an abstract of the other user's Facebook social data, here shown in a Facebook like summary inset box, still while within the Agora virtual party room.

As FIG. 17 also shows, clicking on the other avatar can also expose a menu of various other options, such as Poke (same as a Facebook Poke), Treat, Whisper, or Challenge (to a game). This will be discussed in more detail later.

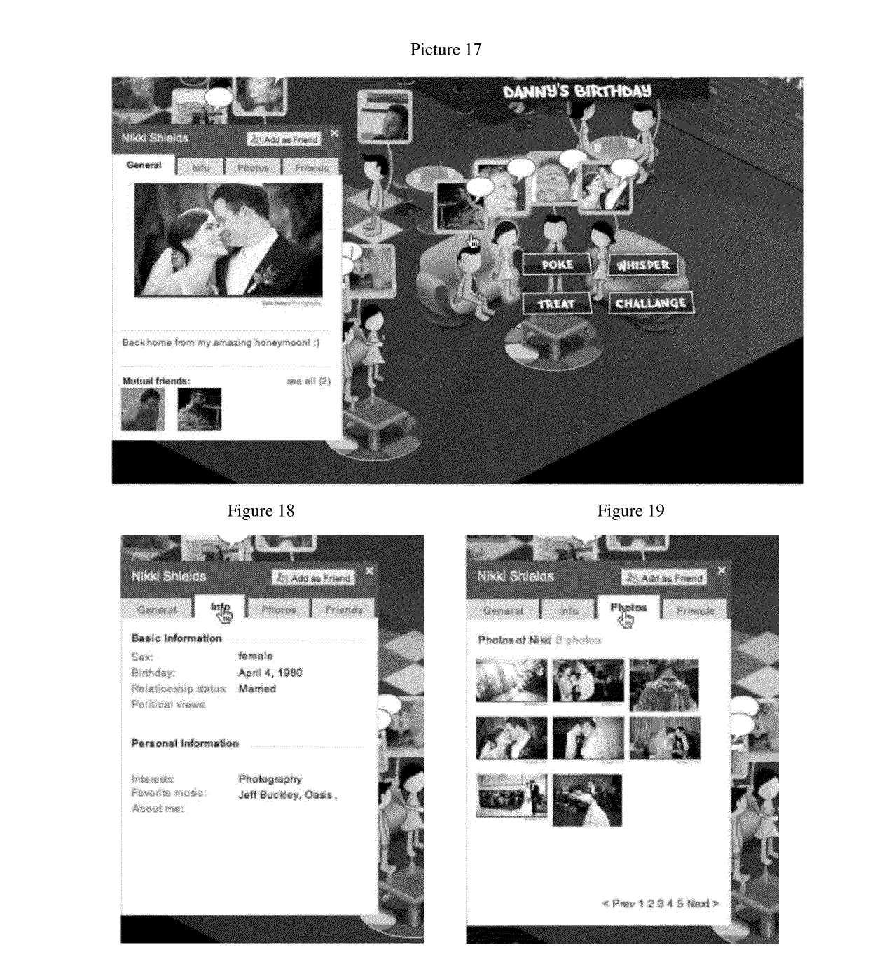

As shown in FIG. 18 and FIG. 19, the mini-abstract of the other user's social data can be examined while still within the context of the Agora virtual party, and by clicking on various hot spots, basic information and photos can be seen.

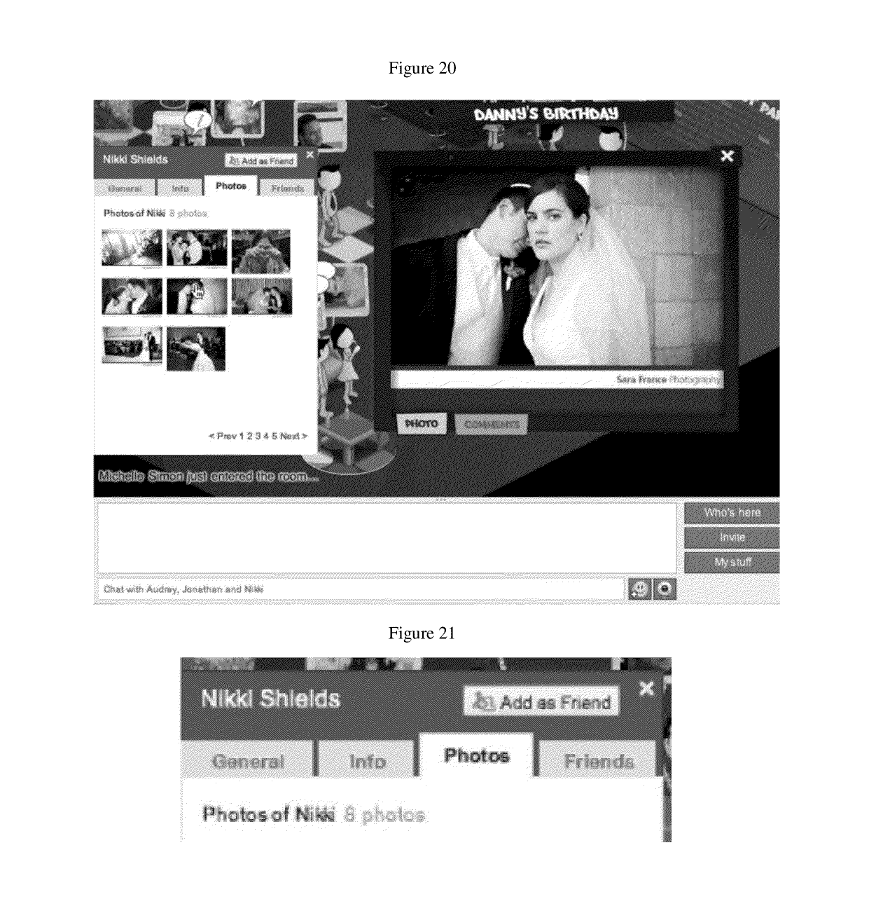

In FIG. 20, the user has clicked onto one of the wedding photos previously shown in FIG. 19, and now can see details of the other user's wedding that the other user has chosen to share on Facebook (or other social network). As before, the user can leave comments on this photo, or not, as desired.

As shown previously, the user is also now within GeoChat conversational distance with three other avatars, and the names of the avatar owners is shown in a chat box at the bottom of FIG. 20. If the user writes something into this chat box, it can be seen by the other users. Similarly if the user now speaks into an audio device, the other users can now hear the user audio and respond if this option is chosen.

The chat box will let the user know exactly who can listen (read) or hear the user's messages and who can respond. If the user starts chatting, all the other local GeoChat users can join the user altogether.

Agora also allows private conversations as well, but here the philosophy behind the Agora GeoChat is to mimic real life party conversations. So to this, the GeoChat option is designed so that only conversations local to the user's avatar can be read.

In alternative embodiments, different approaches may also be used. For example, the chat may instead appear in chat bubbles above the avatar's heads. One drawback of this alternative approach, however, is that this can tend to obscure who is talking to whom, and who is approaching who. This makes it difficult to carry on a conversation with more than one person at a time. Thus in a preferred embodiment, the content of the conversations is shown on a portion of the Agora GUI that is separate from the conversation bubble or icon.

Returning to the social network interface previously shown in FIGS. 17-20, if the user was not already friends with the owner of this avatar (in this case he is), the user would be able to also request that the owner of the other avatar be added as a social network friend by clicking the appropriate hot spot or button. This is shown in FIG. 21.

Again, this social network interaction may be done using an Agora interface that has a seamless interconnection to the affiliated social network, so that social network connections can be made without leaving the Agora virtual party. To help maintain this seamless interaction, in a preferred embodiment, as previously discussed, users may be given the option to at least temporarily adjust their privacy options while in the Agora online virtual event. This option is not unlike a real world party situation, where users may tend to be more open at parties filled with trusted individuals such as friends and friends of friends, yet be more circumspect outside of a party situation.

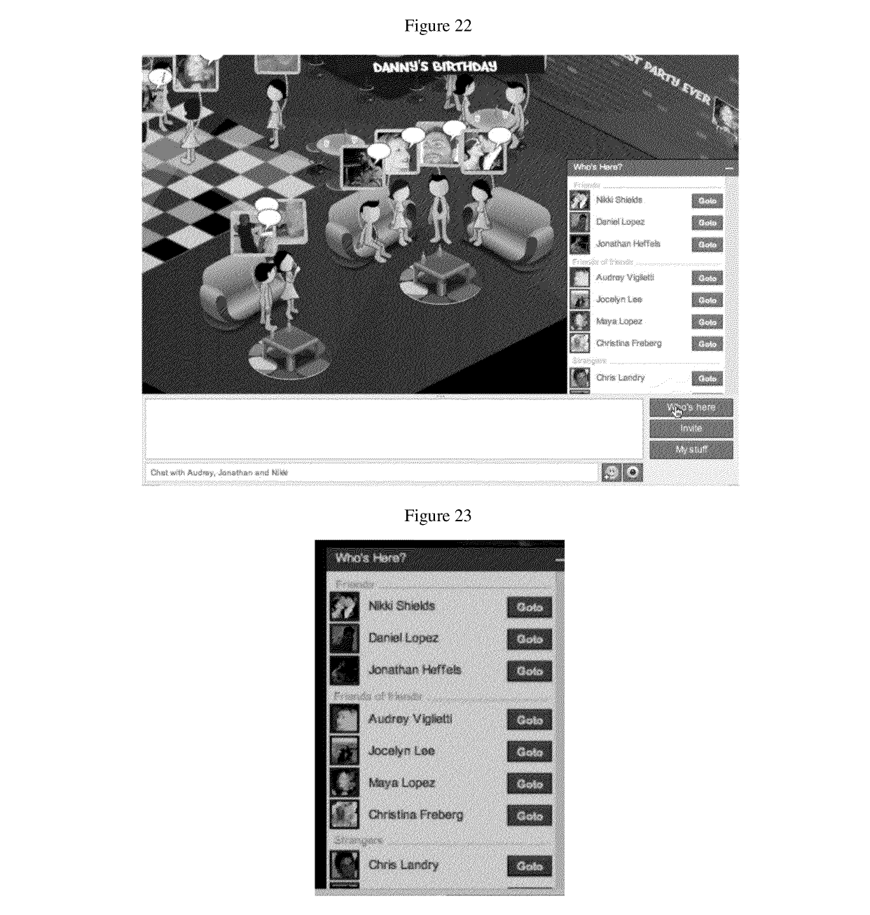

FIG. 22 shows another Agora option, which is a “Who's here?” list, shown in the lower right. A magnified view of this list is shown in FIG. 23.

The “who's here?” list can be list of people who are in the event. This list can optionally be further subdivided into social network friends, friends of friends, and strangers. Other categorizations are also possible. In a preferred embodiment, the “who's here? list” can allow a user to find an individual's avatar by simply clicking on the individual pictured on the “who's here? list”. This option will, for example, cause the user's avatar to “walk” or navigate the user's avatar to the other person's avatar, much the same way that one would normally walk towards another individual in a room.

Turning to another part of the Agora virtual party room, FIG. 24 shows the virtual bar area. Here the user has clicked on the virtual bar stool. This directs the user's avatar to sit on the bar stool, as is shown in FIG. 25. In this example, the other avatar sitting next to the user is color coded (here shown as yellow) as belonging to a friend of a friend.

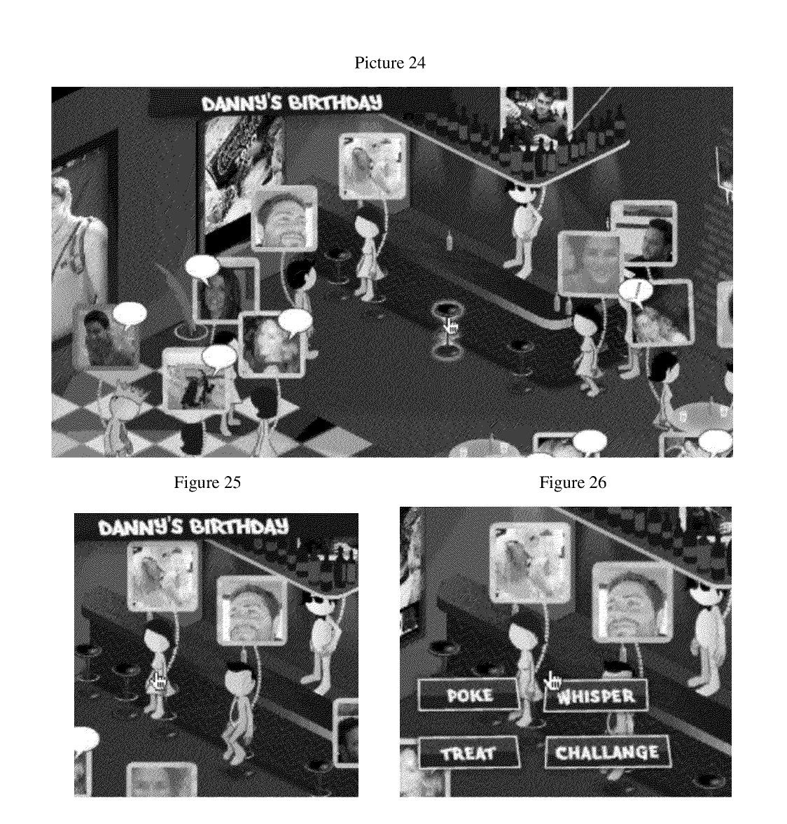

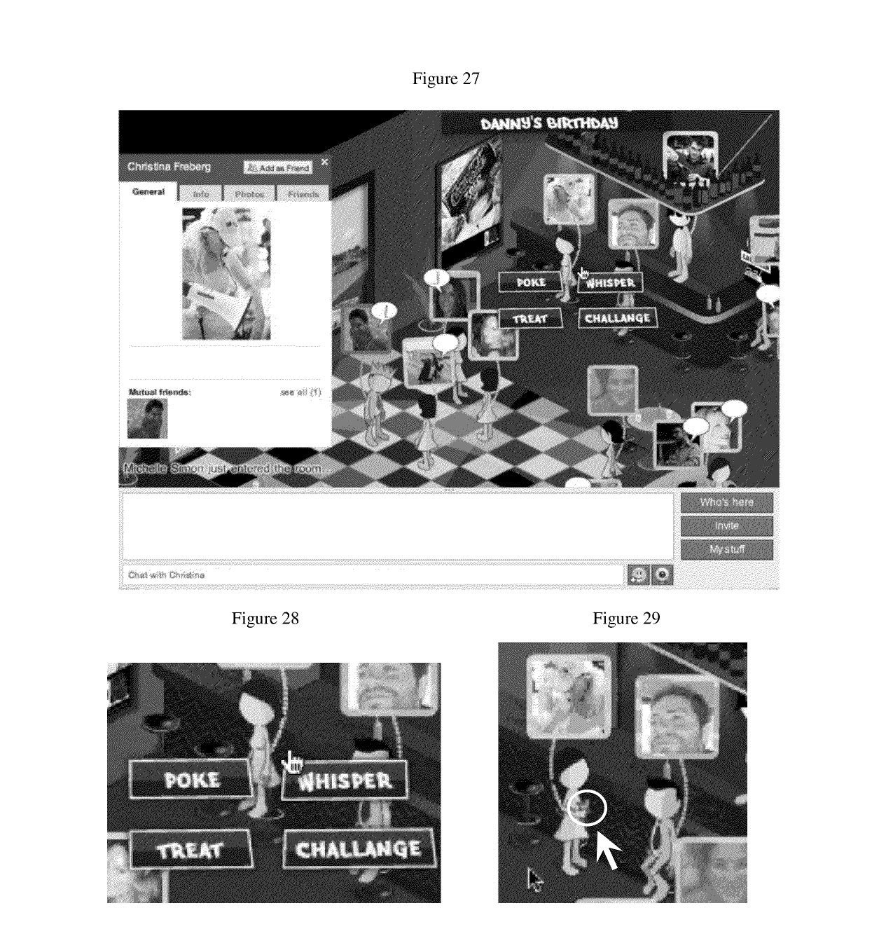

The other user running the yellow avatar (friend of a friend) sitting next to the user's character knows that the user is sitting next to her. When the user clicks on the other avatar, various options to interact with the other user's avatar pop up (FIG. 26), along with an abstracted version of the other user's social network profile, which is shown in FIG. 27.

In FIG. 28, the various interaction options (e.g. Poke, Treat, Whisper, and Challenge to a game) are shown in more detail. In this example, the user from FIG. 5 will show interest in the user of the other avatar by clicking the “Treat” option. In FIG. 29, the results of this “Treat option” are shown, and the user has purchased a virtual “drink” for the other user's avatar, and the other user has accepted, and her avatar is now holding a small graphic showing this drink. This is shown in FIG. 29 inside the circle that is designated by the arrow.

As previously discussed, this virtual gift can, depending on the administrator option, be free or may require a micropayment.

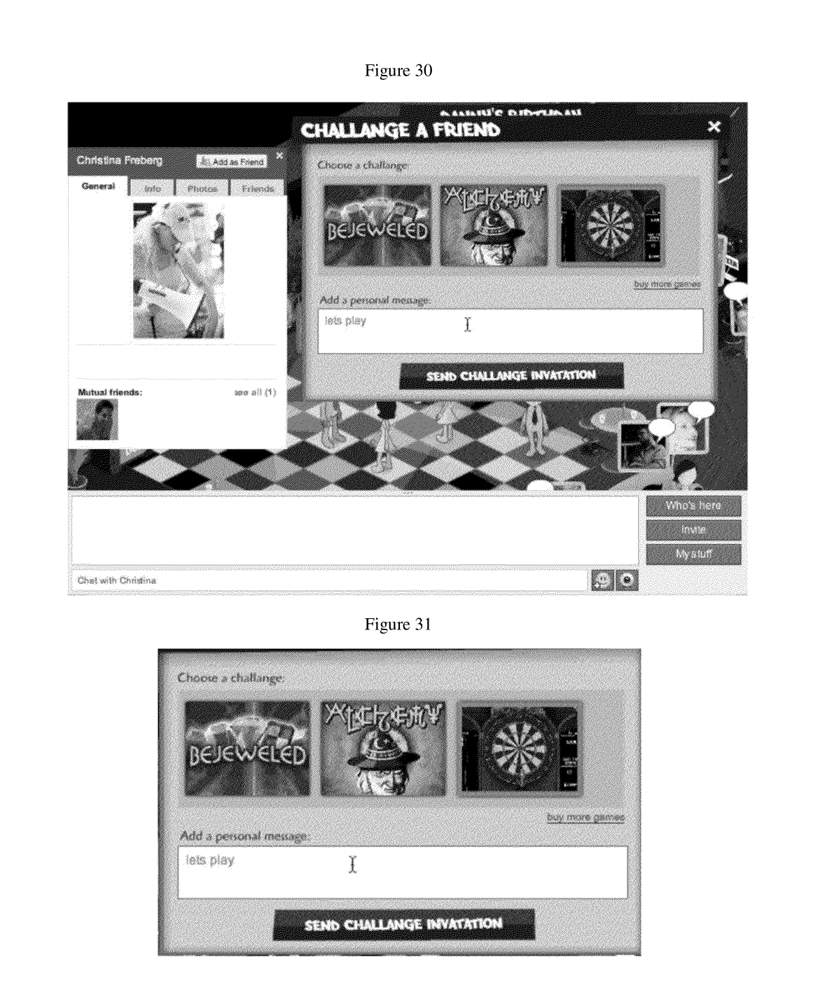

Alternately the user may click on a different option from FIG. 28, such as challenge. The results of selecting “Challenge” are shown in FIG. 30. Here a window marked “Challenge a friend” has opened up, showing various types of game options. The user may communicate with the other user using a personal message box, and for example, send a message such as “let's play”.

A close up of this game interface is shown in FIG. 31. If the other use is interested, she may respond, and in the course of playing the game, more conversation may ensue.

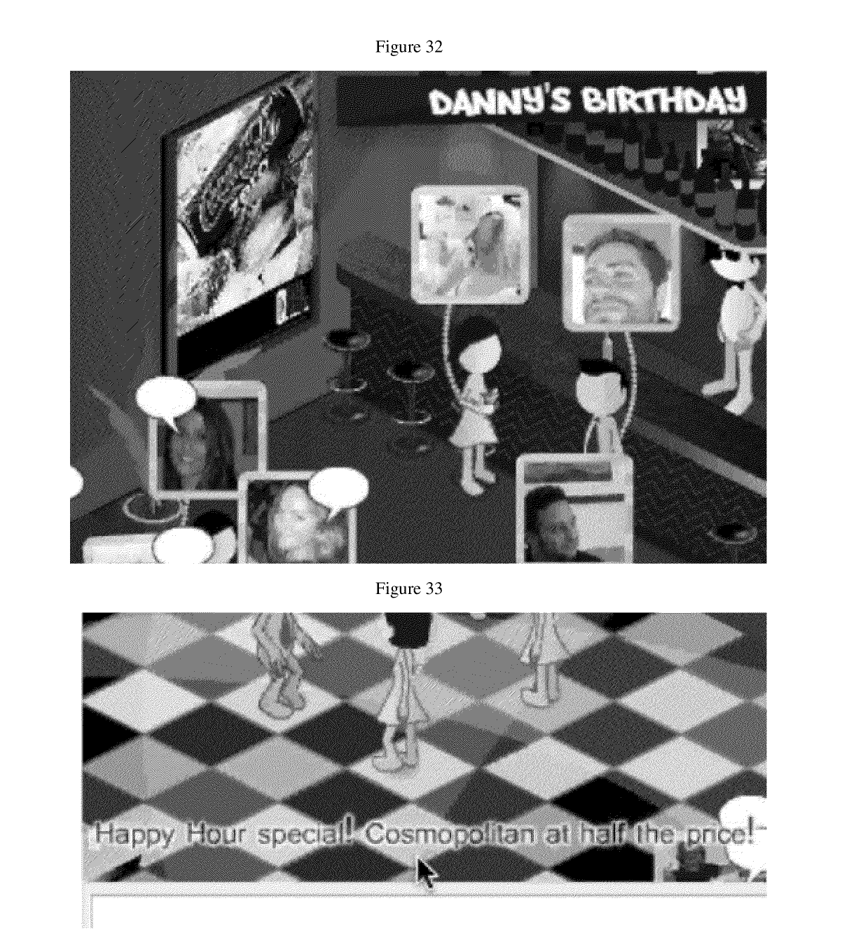

Moving to another Agora feature, FIG. 32 shows that in some embodiments, outside advertisers may advertise in the game, and this can be an additional source of revenues for the operators of the system. For example, in FIG. 32, an advertisement for the soft drink product Coke Zero® is shown.

Other advertising methods can also be implemented. For example, as shown on the bottom of FIG. 33, a commercial organization (which may be an Agora virtual party room, or may be an actual real world organization) is advertising for a happy hour special. This again can be a source of revenues for the operators of the system.

Returning to various communications modalities. Various types of methods may be used to communicate to an entire group of people. For example, in FIG. 34, the user from FIG. 5, perhaps fearing that he will become overly popular, or fearing that the party is becoming too lively, has rather inexplicably decided to share the public message “I love school” with the entire room.

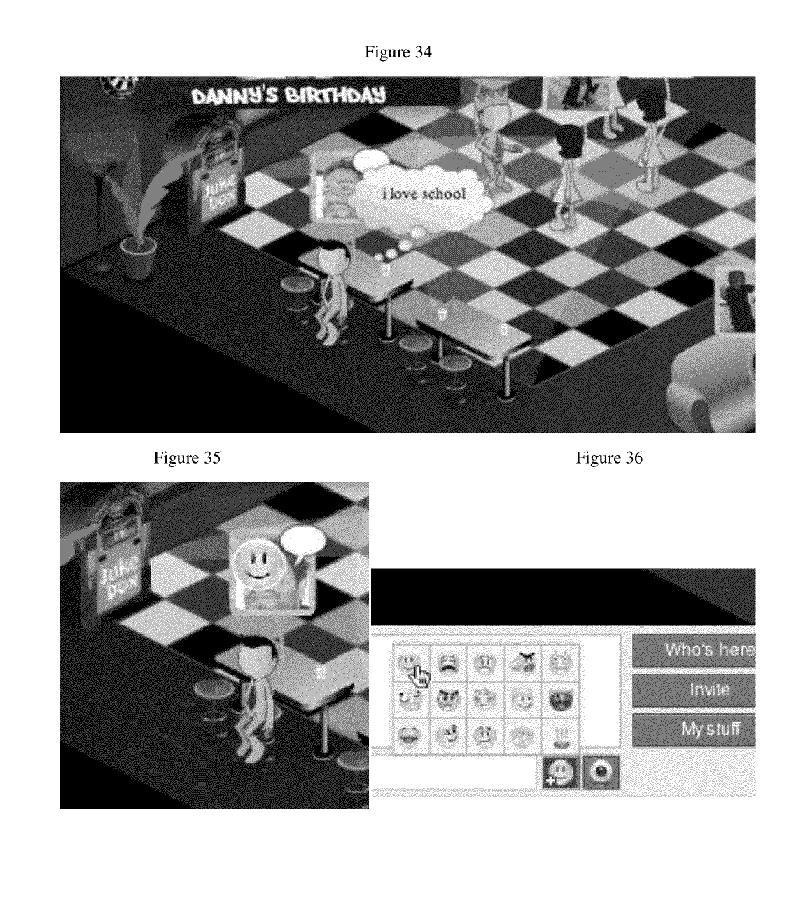

The user from FIG. 5 has further decided to emphasize these profound thoughts with a publically visible emoticon, as is shown in FIG. 35. The emoticon control panel to do this is also visible within the Agora GUI, and this is shown in FIG. 36.

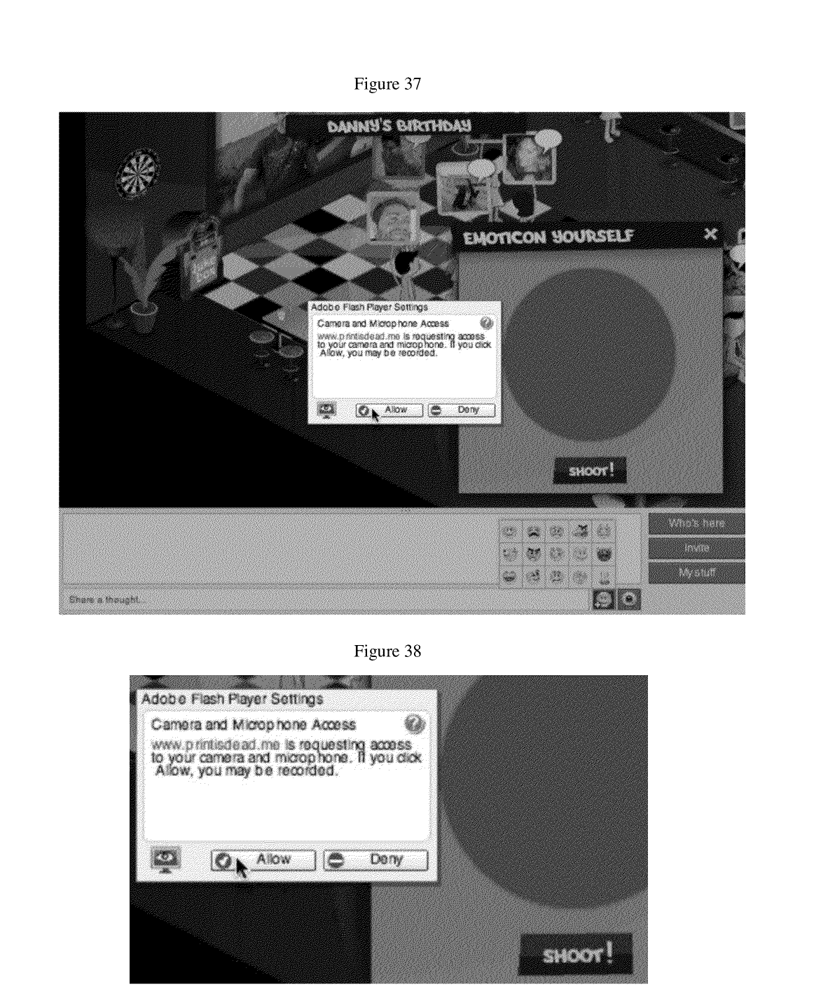

In some embodiments, the system may also allow the user to show a near real-time web cam snapshot image of himself or herself by creating an interface to tie in the user's webcam or other computer operated camera. An example of this type of interface is shown in FIG. 37 and in more detail in FIG. 38. Once the photo is taken, a current snapshot of the user can be taken and shown to the room as a real-time emoticon.

In another option, a snapshot may be taken of the virtual event.

Inviting New People into the Event:

FIG. 39 shows one easy way to invite new people to the Agora event, which is by using an Angora invite list, still within the context of the ongoing Agora online party. Here new participants can be invited using the invite button.

The invite list will also be connected to the participating social network, and in a preferred embodiment will show the user's social network friends that are currently online and on the social network. These friends do not necessarily have to be previously signed up for the Agora service. In this example, when the user clicks on the invite button, a list of currently online friends that are not yet at this Agora event is shown.

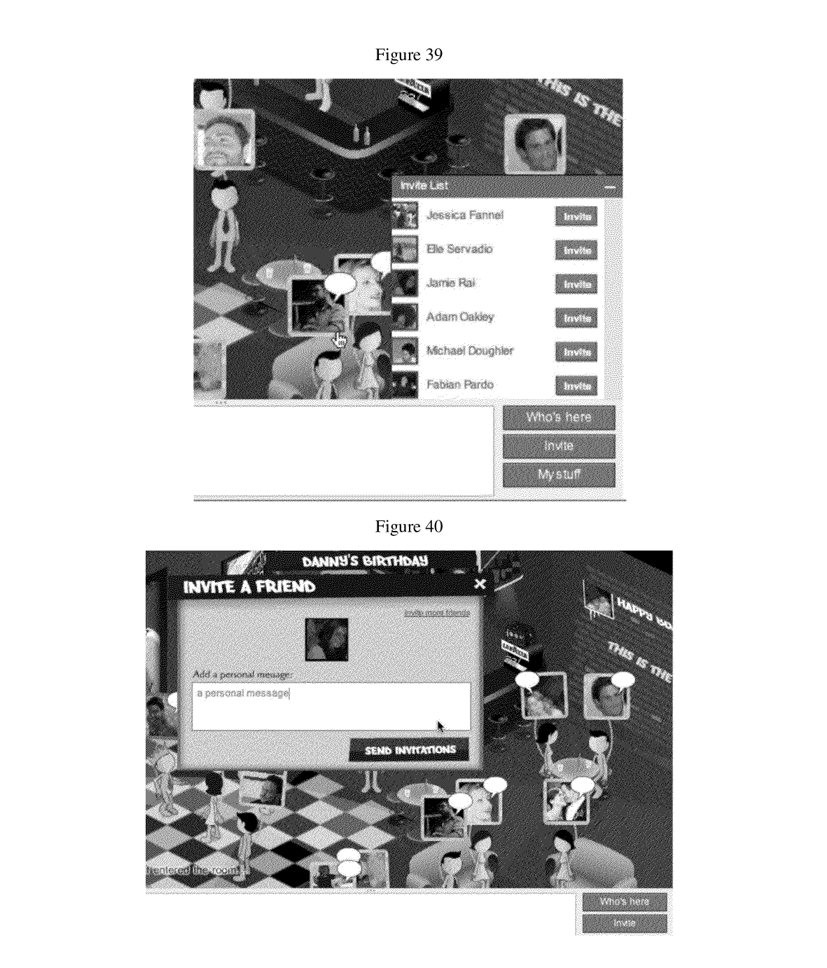

As is shown in FIG. 40, clicking on a particular friend opens up an Agora invite box, and here the user can enter in an optional personal message and invite them.

If the other person accepts, they will promptly end up in the same Agora virtual party room as the user. This way, small Agora events can rapidly grow. Alternatively, the event creator may place some optional constraints on the party size and/or type of friends that may be invited.

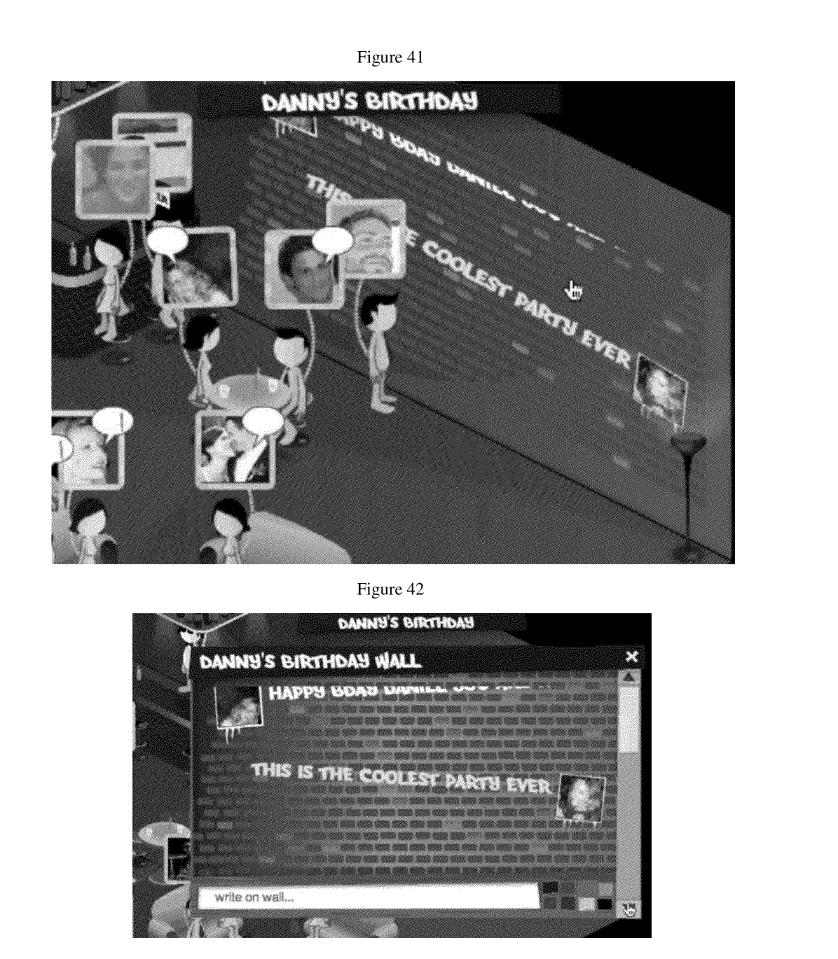

FIG. 41 shows another Agora feature, here called the graffiti wall. Users can click on this wall, and then examine the wall and write on the wall using an interface similar to that shown in FIG. 42. Here the wall may be linked to a Facebook or other social network wall.

The Virtual Events Guide:

An example of an Agora virtual events guide is shown in FIG. 43. The event guide gives a snapshot or overview of the various Agora virtual events. The guide can show Agora events that have already happened, Agora events that are currently happening, and Agora events which will be starting shortly.

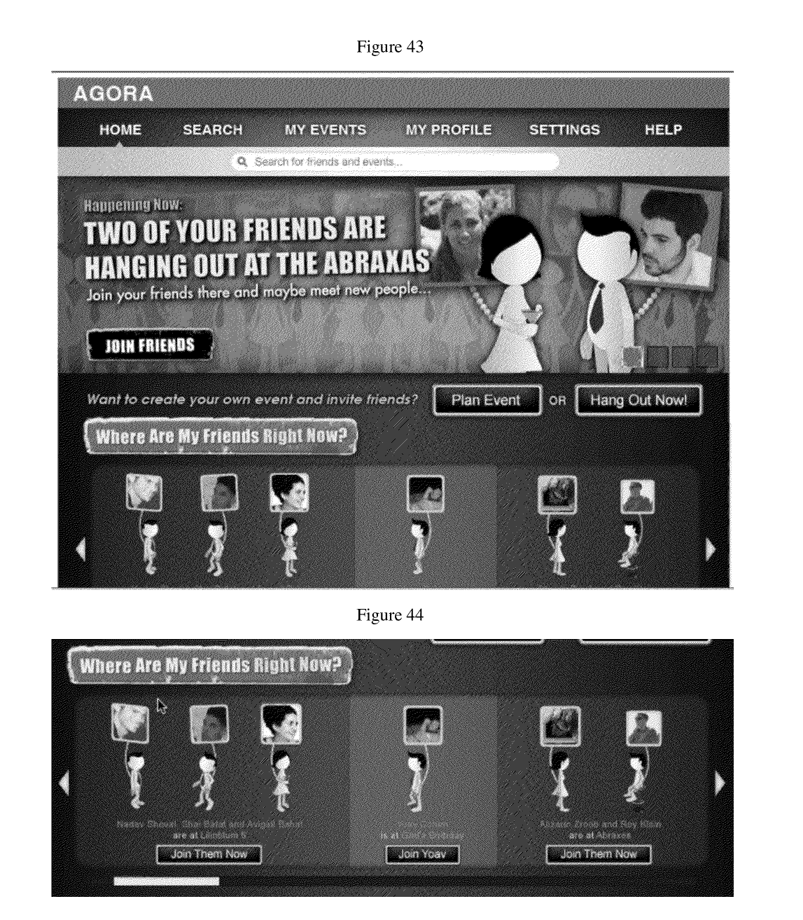

The Agora virtual events guide contains useful features such as the feature “what are my friends doing right now?” This is shown in more detail in FIG. 44. In FIG. 44, three things are happening. One group of three friends is at an Agora virtual party called Lilinblum 6, another friend is at an Agora event entitled Gad's birthday, and two friends are at an Agora event at the Abraxes, a virtual Agora night club. The user can look at these friends, and can click on a group to join the friends in that group immediately.

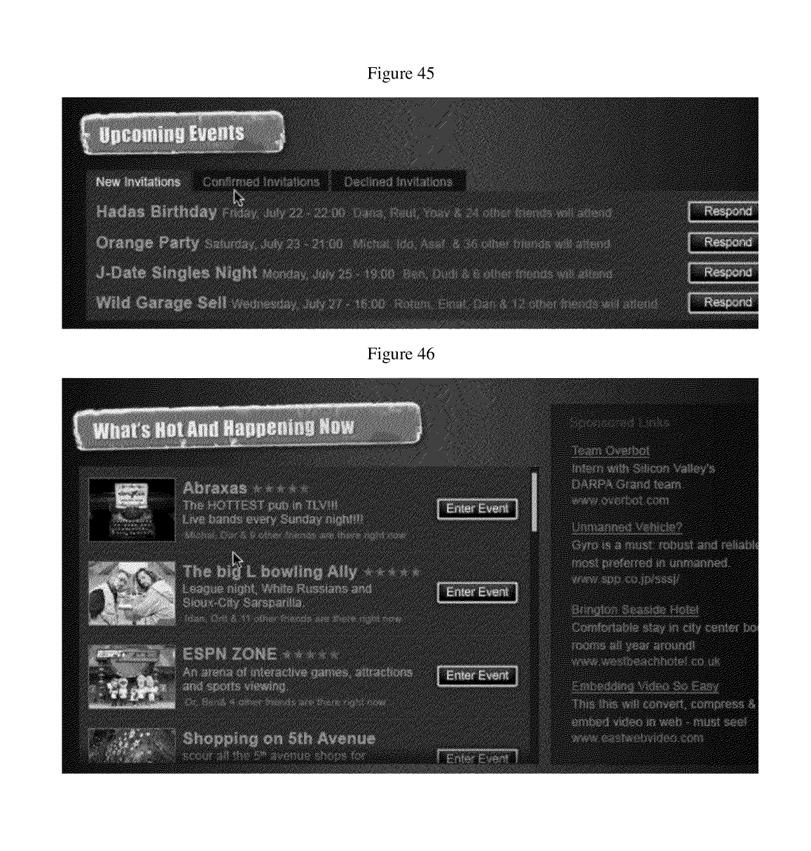

Another useful feature is the “Upcoming events” feature shown in FIG. 45. This feature shows new invitations, as well as previously confirmed and declined invitations. The virtual event guide lets the user schedule future events much like a regular calendar.

Another useful feature is the “What's hot and happening now” feature, shown in FIG. 46. This feature shows the Agora public virtual parties that are currently underway.

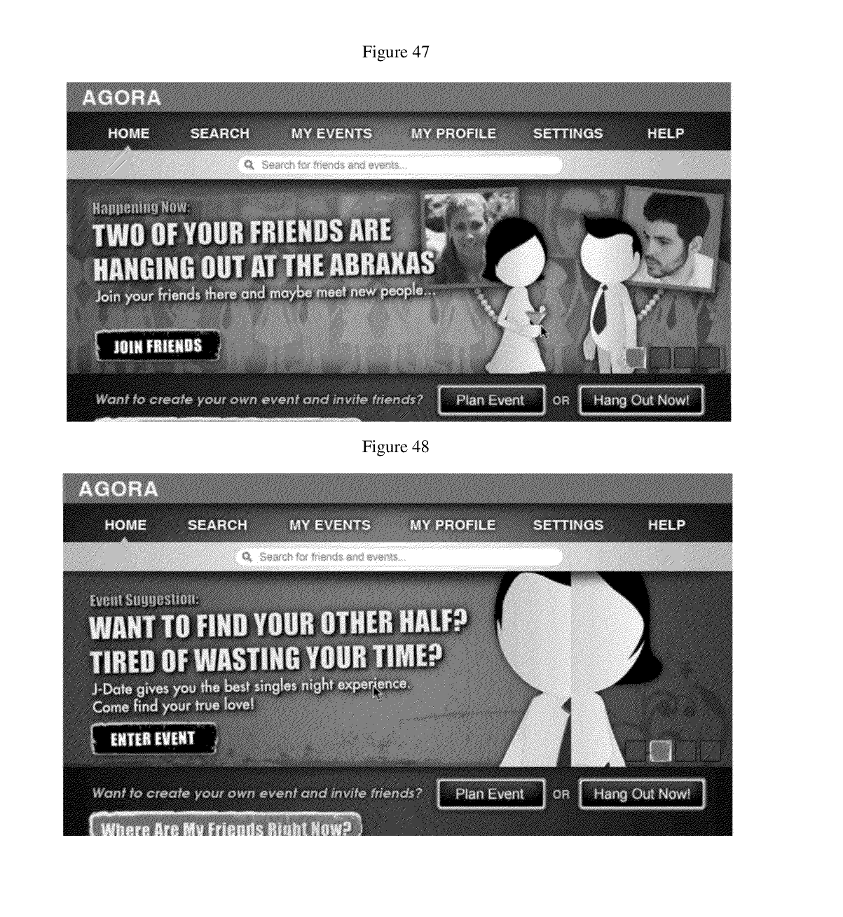

The Agora virtual event guide may also promote various activities. For example, FIG. 47 shows that the application is aware that two of the user's best (highest level of activity with) social network friends are currently hanging out at an Agora virtual party that in this case is commercially sponsored by a real bar that is local to the users. This use of mixed real and virtual events can generate advertising revenue for the system, and also provides a convenient local place for the Agora users to meet later if they decide that they would like to get together in real life.

Alternatively, another sponsor may be promoting a virtual singles party, which again may optionally have a real-life local tie-in so that interested members may again have an opportunity to meet in real life. This is shown in FIG. 48.

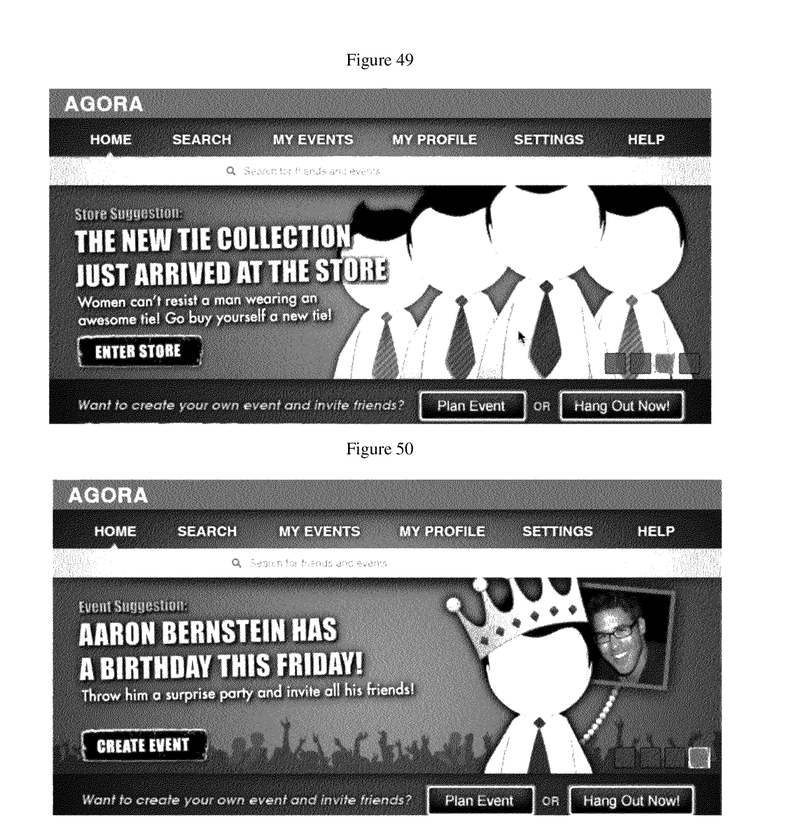

The Agora application may additionally recommend or promote certain real or virtual products. For example, in FIG. 49, the system is promoting virtual avatar ties, likely in exchange for micropayments or viewing of certain sponsored advertisements.

As another example, FIG. 50 shows a different Agora application that prompts the user that a friend has an upcoming birthday or other milestone, for which no Agora event has yet been scheduled. Here the system invites the Agora user start an Agora virtual event for his friend.

As a more streamlined version of this create an event application, by clicking on a “hang out now” button, the user can set up a quick virtual environment, along with a list of what friends are available online now to interact with. Thus by one or two clicks, the user can both create a default virtual world or Agora meeting place, enter it, and start interacting the user's online friends almost immediately.

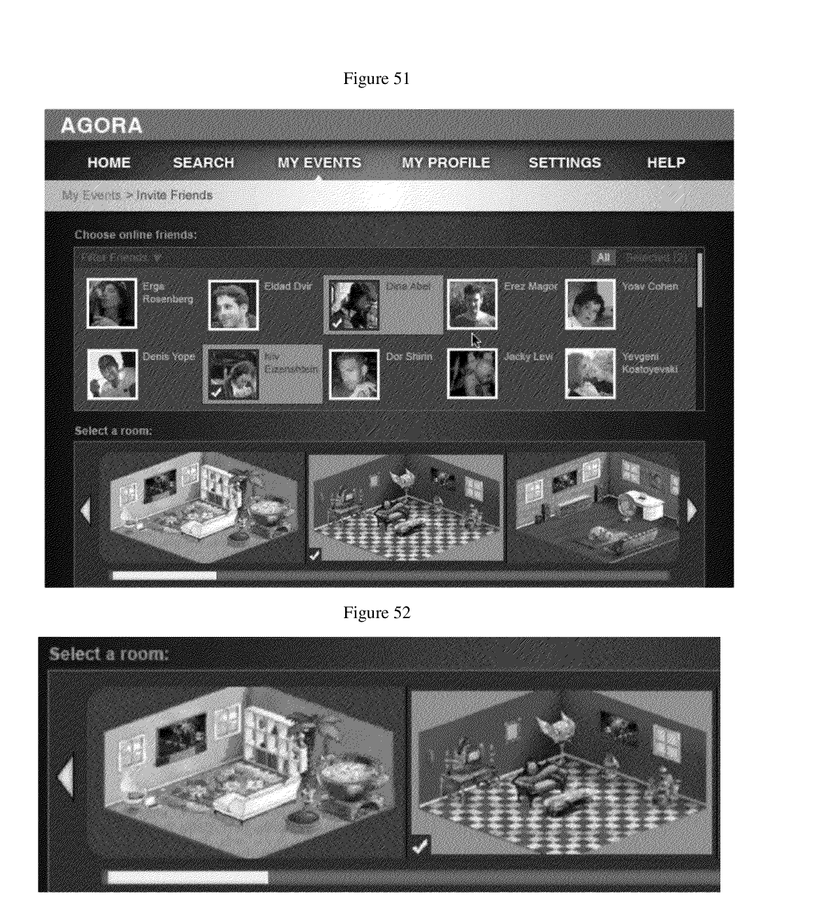

FIGS. 51 and 52 show some of the user interface involved in the Agora “create an event” application. Here the user allows the user to select various pre-made Agora locations, here also pre-populated with various popular items, to reduce the amount of time and effort the user needs to expend in order to create the Agora virtual event. Alternatively more elaborate user interfaces may allow users to create more customized virtual events.

Other functions in this user interface include “plan events”, which will let the user set up the time, invite list, virtual world, virtual world options (virtual location public, private, gadgets present), for this event.

As previously discussed, Agora also may have a location based search function. This search function is shown in FIG. 53. The function allows the user to enter in his or her desired physical location, and search for online (or for that matter, cross connected online-and real life) virtual events that are presently ongoing.

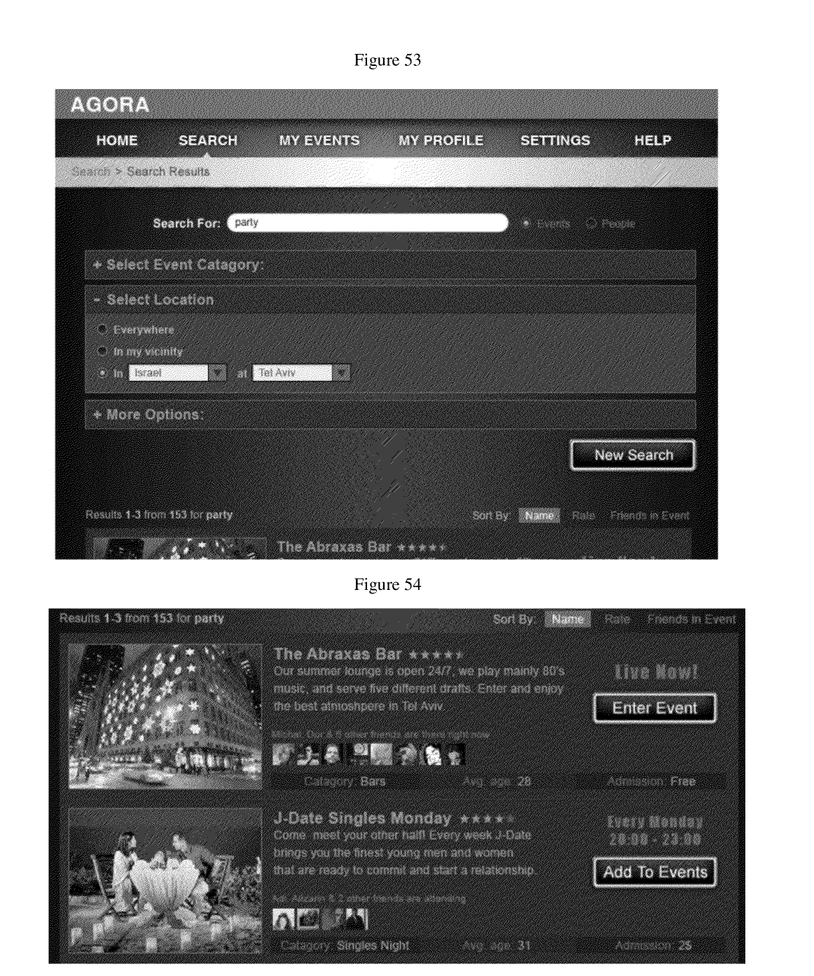

The results of one such search are shown in FIG. 54. This can be a pure virtual event. Alternatively and as previously discussed, in some embodiments, however, a real life commercial organization can sponsor a joint virtual and real-life event. This way, Agora users who are local to the commercial sponsor can decide to meet in real life at the real event, and bring in additional revenues for the sponsor. Even if they do not, the joint virtual—real life tie in can be an important mode of advertising.

In this example, the local Abraxes Bar and J-Date Singles Monthly managers can be either sponsors of a purely virtual event, or alternatively can be sponsors of real life tie-in events as well.

Thus the Agora invention may, in some embodiments, may be thought of as a visual interaction platform. The invention may be designed and implemented in a way that allows Agora to handle any social network that provides the minimal API required to create a user base. Moreover, other types of virtual events, including social shopping environments, commercial campaigns, business meetings, and business conventions may also be implemented using this type of interface.

Agora provides an intuitive visualization layer for the data that is presently locked up in online social networks. Indeed, much of Agora's strength lies in its strong connection to the social network and the user social data—user profiles, photo albums, comments and statuses that are held in the social network. Agora makes this data more useful, and allows compelling virtual meeting environments to be created using this type of information.

1. A method of providing at least one computer network virtual meeting environment for a plurality of avatars, said method comprising:
associating each of said plurality of avatars with user information from at least one social network comprised of a plurality of human users;
wherein said social network contains user information regarding the real world social interactions between said users, user real world photographic information, and user real world biographic information;
using said user photographic information from at least one social network to provide visual labels for said plurality of avatars, thus producing a plurality of social network labeled avatars;
populating said at least one virtual meeting environment with at least some of said plurality of social network labeled avatars;
displaying said at least one virtual meeting environment and at least some of said plurality social network labeled avatars on the graphical user interfaces of computerized network connected devices running under the control of at least some of said users;
wherein said users may control the movement of their respective social network labeled avatars within said at least one virtual meeting environment, interact with the social network labeled avatars belonging to other users, and obtain at least some social network user information based on said interactions.

2. The method of claim 1, wherein the appearance of said social network labeled avatars is further controlled by the social network biographic information or the real world social interactions between said users.

3. The method of claim 2, wherein the social network biographic information includes information pertaining to said user's sex designation, and wherein the appearance of said social network labeled avatars is controlled by said user's social network sex designation.

4. The method of claim 2, wherein the real world social interactions between said users includes the friendship and friends of friends status between users, and wherein the appearance of other users avatars within the graphical user interface of a user's computerized network connected devices are controlled by relative friendship and friends of friends status of said other users relative to said user.

5. The method of claim 4, wherein the color or other visible property of said avatars is controlled by said relative friendship and friends of friends status, or by other user configurable social network parameter.

6. The method of claim 1, wherein said real world photographic information is also displayed on at least some virtual wall spaces in said at least one computer network virtual meeting environment.

7. The method of claim 1, wherein a user may obtain social network information pertaining to another user by clicking on said other user's avatar in said graphical user interface.

8. The method of claim 1, wherein said at least one computer network virtual meeting environment contains at least one object, and said user may interact with said at least one object by clicking on said at least one object.

9. The method of claim 1, wherein said user may converse with other users who have avatars in the immediate proximity of said user's avatar.

10. The method of claim 1, wherein said user may purchase virtual items for the avatars of other users.

11. The method of claim 1, wherein said user may challenge other users who have avatars in the immediate proximity of said user's avatar to a game, or assign other users a task.

12. The method of claim 1, wherein said user may invite said user's social network friends to said at least one computer network virtual meeting environment.

13. The method of claim 1, wherein advertisers may project advertisements on the virtual walls of said at least one computer network virtual meeting environment, or show advertised products as objects within said virtual meeting environment.

14. The method of claim 1, wherein said user may use said user's avatar to broadcast text messages, emoticons, or user supplied images in an emoticon format, within the context of said at least one computer network virtual meeting environment.

15. The method of claim 1, wherein said user may utilize a search engine to determine what other computer network virtual meeting environments are scheduled or presently taking place.

16. The method of claim 1, further displaying the other virtual meeting environments presently being used by said user's social network friends, and providing a rapid means for said user to send said user's avatar to said other virtual meeting environments.

17. The method of claim 1, further providing an interface to allow a user to construct a virtual meeting environment.

18. The method of claim 1, further providing a prompt to inform a user when one of said user's social network friends has an upcoming life milestone, and providing an interface to plan a virtual meeting environment based on said upcoming life milestone.

19. The method of claim 18, wherein said user may create a personal banner featuring said user's social network friends to advertise said virtual meeting environment based on said upcoming life milestone.

20. The method of claim 1, wherein said social network comprises social networks selected from the group consisting of Facebook, MySpace, Twitter, and other social networks.

21. The method of claim 1, wherein said network is the Internet, and said graphical user interface is the graphical user interface of a web browser.

22. The method of claim 1, wherein the display of said at least one virtual meeting environment is selected from the group consisting of 2D isometric displays, 2D overhead displays, 3D first person displays, 3D behind and above the first person display, and other 3D displays.
